(19) United States
(12) Patent Application Publication
(10) Pub. No.: US 2020/0383004 A1
(43) Pub. Date: Dec. 3, 2020

(54) TRAFFIC BURST AWARENESS IN COMMUNICATION SYSTEMS

(71) Applicant: QUALCOMM Incorporated, San Diego, CA (US)

(72) Inventors: Prashanth Haridas HANDE, San Diego, CA (US); Hong CHENG, Bridgewater, NJ (US); Haris ZISIMOPOULOS, London (GB); Jay Kumar SUNDARARAJAN, San Diego, CA (US); Peter Pui Lok Ang, San Diego, CA (US); Gavin Bernard HORN, La Jolla, CA (US); Yeliz Tokgoz, San Diego, CA (US)

(21) Appl. No.: 16/885,796

(22) Filed: May 28, 2020

Related U.S. Application Data
(60) Provisional application No. 62/859,468, filed on Jun. 10, 2019.

(30) Foreign Application Priority Data
May 31, 2019 (GR) 20190100238

(51) Int. Cl. H04W 28/22; H04W 48/06; H04W 28/02; H04W 76/28; H04W 24/08; H04W 72/04

(52) U.S. Cl. CPC H04W 28/22; H04W 48/06; H04W 72/042; H04W 76/28; H04W 24/08; H04W 28/0268

(57) ABSTRACT

Certain aspects of the present disclosure provide techniques for traffic burst awareness in wireless systems. An application function, such as via an application server, can determine one or more burst parameters associated with a traffic flow for at least one service. The application function can send the one or more burst parameters a network. The burst parameters may include a burst factor associated with a minimum bit rate for providing service coverage for the traffic flow and/or a burst spread. A core network and/or access network (AN) entity can obtain the burst parameters and utilize the burst factor for communicating with a user equipment (UE). The CN and/or AN may use the burst parameters for admission control, resource allocation, and/or setting sleep mode parameters.

### CROSS-REFERENCE TO RELATED APPLICATION(S)

This application claims benefit of and priority to Greek Application No. 20190100238, filed May 31, 2019, and to U.S. Provisional Application No. 62/859,468, filed Jun. 10, 2019, both of which are hereby assigned to the assignee hereof and hereby expressly incorporated by reference herein in their entireties as if fully set forth below and for all applicable purposes.

### INTRODUCTION

Aspects of the present disclosure relate to wireless communications, and more particularly, to techniques for communications in wireless systems.

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include a traffic burst factor aware wireless network that may perform improved admission control and/or resource allocation.

Certain aspects provide a method for communications. The method generally includes obtaining one or more burst parameters associated with a traffic flow for at least one service. The method generally includes communicating with a user equipment (UE) based on the one or more burst parameters.

Certain aspects provide a method for communications. The method generally includes determining one or more burst parameters associated with a traffic flow for at least one service. The method generally includes sending the one or more parameters to a network.

Certain aspects provide an apparatus for communications. The apparatus generally includes at least one processor and a memory coupled to the at least one processor. The at least one processor and the memory are configured to obtain one or more burst parameters associated with a traffic flow for at least one service and communicate with a UE based on the one or more burst parameters.

Certain aspects provide an apparatus for communications. The apparatus generally includes at least one processor and a memory coupled to the at least one processor. The at least one processor and the memory are configured to determine one or more burst parameters associated with a traffic flow for at least one service and send the one or more parameters to a network.

Certain aspects provide an apparatus for communications. The apparatus generally includes means for obtaining one or more burst parameters associated with a traffic flow for at least one service. The apparatus generally includes means for communicating with a UE based on the one or more burst parameters.

Certain aspects provide an apparatus for communications. The apparatus generally includes means for determining one or more burst parameters associated with a traffic flow for at least one service. The apparatus generally includes means for sending the one or more parameters to a network.

Certain aspects provide a computer readable medium storing computer executable code thereon. The computer readable medium generally stores code for obtaining one or more burst parameters associated with a traffic flow for at least one service. The computer readable medium generally includes code for communicating with a UE based on the one or more burst parameters.

Certain aspects provide a computer readable medium storing computer executable code thereon. The computer readable medium generally stores code for determining one or more burst parameters associated with a traffic flow for at least one service. The computer readable medium generally includes code for sending the one or more parameters to a network.

Certain aspects provide a method for communications. The method generally includes obtaining a burst factor associated with a minimum link rate and a latency at which coverage is provided for a traffic flow for at least one service. The method generally includes utilizing the burst factor for admission control, resource allocation, or both.

Certain aspects provide a method for communications. The method generally includes determining a burst factor associated with a minimum link rate and a latency at which coverage is provided for a traffic flow for at least one service, information associated with the burst factor, or both. The method generally includes sending the burst factor, the information associated with the burst factor, or both to a network.

Certain aspects provide an apparatus for communications. The apparatus generally includes means for obtaining a burst factor associated with a minimum link rate and a latency at which coverage is provided for a traffic flow for at least one service. The apparatus generally includes means for utilizing the burst factor for admission control, resource allocation, or both.

Certain aspects provide an apparatus for communications. The apparatus generally includes means for determining a burst factor associated with a minimum link rate and a latency at which coverage is provided for a traffic flow for at least one service, information associated with the burst factor, or both. The apparatus generally includes means for sending the burst factor, the information associated with the burst factor, or both to a network.

Certain aspects provide an apparatus for communications. The apparatus generally includes a memory and at least one processor coupled with the memory. The at least one processor and the memory are configured to obtain a burst factor associated with a minimum link rate and a latency at which coverage is provided for a traffic flow for at least one service. The at least one processor is further configured to utilize the burst factor for admission control, resource allocation, or both.

Certain aspects provide an apparatus for communications. The apparatus generally includes a memory and at least one processor coupled with the memory. The at least one processor and the memory are configured to determine a burst factor associated with a minimum link rate and a latency at which coverage is provided for a traffic flow for at least one service, information associated with the burst factor, or both. The at least one processor is further configured to send the burst factor, the information associated with the burst factor, or both to a network.

Certain aspects provide a computer readable medium storing computer executable code thereon. The computer readable medium generally stores code for obtaining a burst factor associated with a minimum link rate and a latency at which coverage is provided for a traffic flow for at least one service. The computer readable medium generally stores code for utilizing the burst factor for admission control, resource allocation, or both.

Certain aspects provide a computer readable medium storing computer executable code thereon. The computer readable medium generally stores code for determining a burst factor associated with a minimum link rate and a latency at which coverage is provided for a traffic flow for at least one service, information associated with the burst factor, or both. The computer readable medium generally stores code for sending the burst factor, the information associated with the burst factor, or both to a network.

Certain aspects provide a method for wireless communication. The method generally includes determining one or more burst parameters associated with bursts of file transmissions, each burst having one or more files, each file having a plurality of packets comprising at least one of a plurality of uplink packets or a plurality of downlink packets. The method also includes setting one or more sleep mode parameters based on the one or more burst parameters and communicating the bursts with a user equipment (UE) in accordance with the one or more burst parameters.

Certain aspects provide a method for wireless communication. The method generally includes receiving, from a network entity, an indication of one or more sleep mode parameters and switching to a sleep mode based on the indication. The method also includes communicating bursts of file transmissions with the network entity in accordance with one or burst parameters associated with the bursts, each burst having one or more files, each file having a plurality of packets comprising at least one of a plurality of uplink packets or a plurality of downlink packets.

Certain aspects provide an apparatus for wireless communication. The apparatus generally includes at least one processor and a memory coupled with the at least one processor. The at least one processor and the memory are configured to determine one or more burst parameters associated with bursts of file transmissions, each burst having one or more files, each file having a plurality of packets comprising at least one of a plurality of uplink packets or a plurality of downlink packets. The at least one processor and the memory are configured to set one or more sleep mode parameters based on the one or more burst parameters and communicating the bursts with a UE in accordance with the one or more burst parameters.

Certain aspects provide an apparatus for wireless communication. The apparatus generally includes at least one processor and a memory coupled with the at least one processor. The at least one processor and the memory are configured to receive, from a network entity, an indication of one or more sleep mode parameters and switch to a sleep mode based on the indication. The at least one processor and the memory are configured to communicate bursts of file transmissions with the network entity in accordance with one or burst parameters associated with the bursts, each burst having one or more files, each file having a plurality of packets comprising at least one of a plurality of uplink packets or a plurality of downlink packets.

Certain aspects provide an apparatus for wireless communication. The apparatus generally includes means for determining one or more burst parameters associated with bursts of file transmissions, each burst having one or more files, each file having a plurality of packets comprising at least one of a plurality of uplink packets or a plurality of downlink packets. The apparatus also includes means for setting one or more sleep mode parameters based on the one or more burst parameters and communicating the bursts with a UE in accordance with the one or more burst parameters.

Certain aspects provide an apparatus for wireless communication. The apparatus generally includes means for receiving, from a network entity, an indication of one or more sleep mode parameters and means for switching to a sleep mode based on the indication. The apparatus also includes means for communicating bursts of file transmissions with the network entity in accordance with one or burst parameters associated with the bursts, each burst having one or more files, each file having a plurality of packets comprising at least one of a plurality of uplink packets or a plurality of downlink packets.

Certain aspects provide a computer readable medium storing computer executable code thereon. The computer readable medium generally stores code for determining one or more burst parameters associated with bursts of file transmissions, each burst having one or more files, each file having a plurality of packets comprising at least one of a plurality of uplink packets or a plurality of downlink packets. The computer readable medium generally stores code for setting one or more sleep mode parameters based on the one or more burst parameters and communicating the bursts with a UE in accordance with the one or more burst parameters.

Certain aspects provide a computer readable medium storing computer executable code thereon. The computer readable medium generally stores code for receiving, from a network entity, an indication of one or more sleep mode parameters and code for switching to a sleep mode based on the indication. The computer readable medium generally stores code for communicating bursts of file transmissions with the network entity in accordance with one or burst parameters associated with the bursts, each burst having one or more files, each file having a plurality of packets comprising at least one of a plurality of uplink packets or a plurality of downlink packets.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example wireless communication network, in accordance with certain aspects of the present disclosure.

FIG. 2 is a block diagram illustrating an example architecture of a core network (CN) and radio access network (RAN) in communication with an application server (AS), in accordance with certain aspects of the present disclosure.

FIG. 3 is a block diagram conceptually illustrating a design of an example base station (BS) and user equipment (UE), in accordance with certain aspects of the present disclosure.

FIG. 4 is an example frame format for certain wireless communication systems (e.g., new radio (NR)), in accordance with certain aspects of the present disclosure.

FIG. 5 is a table showing example traffic flow quality-of-service (QoS) parameters for various services, in accordance with certain aspects of the present disclosure.

FIG. 6 is a table showing example QoS parameters for two traffic flows for virtual reality (VR) service with different burst factors, in accordance with certain aspects of the present disclosure.

FIG. 7 is an example traffic arrival pattern for VR traffic, in accordance with certain aspects of the present disclosure.

FIG. 8 is an example traffic arrival pattern for VR traffic, in accordance with certain aspects of the present disclosure.

FIG. 9 is a flow diagram illustrating example operations for communications that can be performed by a CN entity and/or a RAN entity, in accordance with certain aspects of the present disclosure.

FIG. 10 is a flow diagram illustrating example operations for communications that can be performed by an AS, in accordance with certain aspects of the present disclosure.

FIG. 11 is an example call flow diagram illustrating example signaling, in accordance with certain aspects of the present disclosure.

FIG. 12 illustrates an example communications device that may include various components configured to perform operations for the techniques disclosed herein in accordance with aspects of the present disclosure.

FIG. 13 illustrates an example communications device that may include various components configured to perform operations for the techniques disclosed herein in accordance with aspects of the present disclosure.

FIG. 14 illustrates a wireless communication system for XR.

FIG. 15 illustrates a traffic flow for communication of packets associated with various files.

FIG. 16 illustrates an example XR traffic flow of file bursts, in accordance with certain aspects of the present application.

FIG. 17A illustrates an example communication flow of burst parameters from an application function of a server entity to the RAN, in accordance with certain aspects of the present application.

FIG. 17B illustrates another example communication flow of the burst parameters from a data network of a server entity to the RAN, in accordance with certain aspects of the present disclosure.

FIG. 17C illustrates an example communication flow of the burst parameters from the UE to the RAN, in accordance with certain aspects of the present disclosure.

FIG. 18 is a call flow diagram illustrating example operations for enabling file burst awareness of downlink traffic, in accordance with certain aspects of the present disclosure.

FIG. 19 is a call flow diagram illustrating example operations for enabling file burst awareness of uplink traffic, in accordance with certain aspects of the present disclosure.

FIG. 20 is a flow diagram illustrating example operations for wireless communication by a network entity, in accordance with certain aspects of the present disclosure.

FIG. 21 is a flow diagram illustrating example operations for wireless communication by a UE, in accordance with certain aspects of the present disclosure.

FIG. 22 is a flow diagram illustrating example operations for wireless communication by a network entity, in accordance with certain aspects of the present disclosure.

FIG. 23 is a flow diagram illustrating example operations for wireless communication by an AS, in accordance with certain aspects of the present disclosure.

FIG. 24 illustrates a communications device that may include various components configured to perform operations for the techniques disclosed herein in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for traffic awareness in communication systems. Some communication systems, such as new radio systems (e.g., 5G NR) support various services such as extended reality (XR).

XR service may refer to services such augmented reality (AR), virtual reality (VR), cloud gaming, split rendering, split computation, and mixed reality (MR). AR and VR service may be characterized by a human being interacting with the environment or people, or controlling a UE, and relying on audio-visual feedback. XR service may use low latency (e.g., a packet delay budget (PDB) of between 5 ms and 25 ms) communications with a highly reliable bit-rate (e.g., a packet error rate of less than or equal to 1e-3). Cloud gaming generally refers to gaming on a user device where at least some of the graphical processor unit (GPU) processing is performed on a cloud server where more powerful GPUs may be implemented. Similarly, GPU processing for VR and AR may be split between a GPU on the cloud and a GPU on the user device. However, cloud gaming, split rendering, and split computation services use low latency communications to maintain an acceptable gaming or virtual experience. Cloud gaming may be implemented using quality-of-service (QoS) or over the top (OTT) on a 5G network. Different use cases may have different location and mobility requirements.

It may be desirable for a communication network, for example such as 5G NR, to be aware of traffic burst information associated with a service/traffic flow. Aspects of the present disclosure provide approaches for traffic burst awareness in the communication network.

In XR applications, a traffic flow may include bursts of files comprising multiple packets. The radio access network (RAN) may determine or receive the structure of the bursts (e.g., start time, end time, duration, or period) and configure power saving settings for a user equipment (UE) in accordance with the burst structure. For example, the RAN may receive an indication of the burst start times and burst durations from a server entity (e.g., an edge server, cloud gaming server, or virtual reality server), and the RAN may then take into account the structure of the bursts when configuring a sleep mode cycle (e.g., a discontinuous reception (DRX) cycle) for the UE receiving or transmitting the traffic flow.

Aspects provide for the application provider (e.g., an application server for an application on a UE) to compute a traffic burst factor associated with the application traffic. The traffic burst factor may be associated with the traffic pattern (e.g., associated with the traffic burst size and/or arrival pattern of the traffic) for a traffic flow (e.g., a traffic flow between a UE and a base station (BS) for an application). The burst factor may be a multiplicative factor for a guaranteed bit rate (GBR) to define a minimum bit rate for providing service coverage for the traffic flow.

The application provider may signal the traffic burst factor, or information related to the traffic burst factor, to an entity in a wireless communication network (e.g., such as a core network entity). The entity in the wireless communication network can determine the traffic burst factor based on the signaled traffic burst factor or the information related to the traffic burst factor. The network entity may provide the traffic burst factor, or information related to the traffic burst factor, to other network entities. The traffic burst factor can be used within the wireless communication network for admission control and/or resource allocation. In some examples, an admission controller (e.g., at a BS) can use the burst factor to determine whether to admit a traffic flow for the application based, at least in part, on the traffic burst factor. In some examples, a scheduler (e.g., at a BS) can allocate resources to one or more UEs based, at least in part, on the traffic burst factor.

The following description provides examples of traffic awareness in communication systems, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs.

The techniques described herein may be used for various wireless networks and radio technologies. While aspects may be described herein using terminology commonly associated with 3G, 4G, and/or new radio (e.g., 5G NR) wireless technologies, aspects of the present disclosure can be applied in other generation-based communication systems.

NR access may support various wireless communication services, such as enhanced mobile broadband (eMBB) targeting wide bandwidth (e.g., 80 MHz or beyond), millimeter wave (mmW) targeting high carrier frequency (e.g., 24 GHz to 53 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe. NR supports beamforming and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

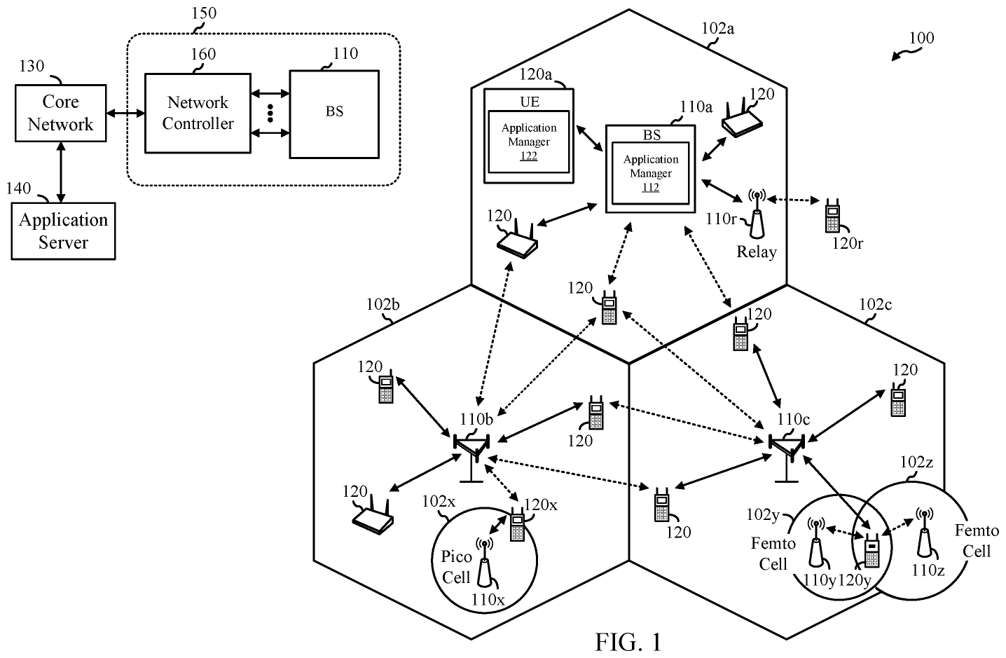

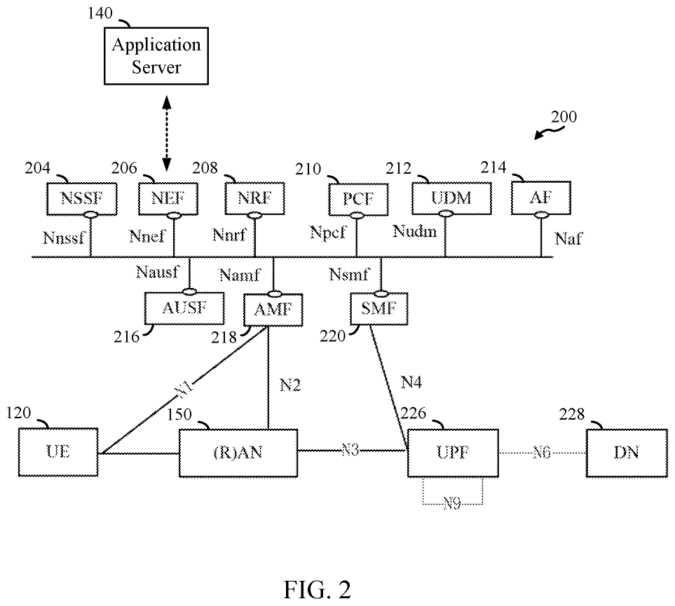

FIG. 1 illustrates an example wireless communication network 100 in which aspects of the present disclosure may be performed. For example, the wireless communication network 100 may be an NR system (e.g., a 5G NR network). A radio access network (RAN) 150 may include a network controller 160 and the BSs 110. The RAN 150 may be in communication with a core network 130 and an application server 140, as discussed in more detail herein with respect to FIG. 2.

As illustrated in FIG. 1, the wireless communication network 100 may include a number of BSs 110a-z (each also individually referred to herein as BS 110 or collectively as BSs 110) and other network entities. A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple cells. The BSs 110 communicate with UEs 120a-y (each also individually referred to herein as UE 120 or collectively as UEs 120) in the wireless communication network 100. The UEs 120 (e.g., 120x, 120y, etc.) may be dispersed throughout the wireless communication network 100, and each UE 120 may be stationary or mobile.

According to certain aspects, the BSs 110 and UEs 120 may be configured for one or more services (e.g., URLLC, eMBB, XR, etc.) involving traffic flows between the application provider (e.g., the application server 140) and/or BSs 110 and UEs 120 associated with one or more applications running on the UEs 120.

For example, the UE 120a may be requesting admission (e.g., requesting the BS 110a to serve as a link between the UE 120a and the AS 140) for the one or more traffic flows for a service related to an application. As shown in FIG. 1, the BS 110a includes an application manager 112. The application manager 112 may be configured to obtain a traffic burst factor associated with a minimum link rate and a latency at which coverage is provided for a traffic flow for at least one service, in accordance with aspects of the present disclosure. In some examples, the application manager 112 may receive signaling from the CN 130 indicating the traffic burst factor. In some examples, the application manager 112 may receive information from the CN 130 related to the traffic burst factor and the application manager 112 calculates the burst factor based on the information. The CN 130 may have received the traffic burst factor or information related to the traffic burst factor from the application provider (e.g., from the application server 140). The application manager 112 may be configured to utilize the traffic burst factor for admission control, resource allocation, or both, in accordance with certain aspects of the present disclosure. In some examples, the application manager 112 may admit a traffic flow or service requested by the UE 120a based on the traffic burst factor or may provide the traffic burst factor to an admission control device to admit or deny the service. In some examples, the application manager 112 may perform resource allocation for the UE 120a and/or another UE 120 based on the traffic burst factor.

In some examples, the UE 120a includes an application manager 122 that may be configured for enhancing file-based services such as XR, according to aspects described herein. The application manager 112 may also be configured for enhancing file-based services such as XR, as described in more detail herein.

Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

FIG. 2 is a block diagram illustrating an example architecture of a CN 200 (e.g., such as the CN 130 in FIG. 1) in communication with a RAN 224 and AS 202 (e.g., such as the AS 140 in FIG. 1), in accordance with certain aspects of the present disclosure. As shown in FIG. 2, the example architecture includes the CN 200, RAN 224, UE 222, and data network (DN) 228 (e.g. operator services, Internet access or third party services).

The CN 200 may host core network functions. CN 200 may be centrally deployed. CN 200 functionality may be offloaded (e.g., to advanced wireless services (AWS)), in an effort to handle peak capacity. As shown in FIG. 2, the example CN 200 may be implemented by one or more network entities that perform network functions (NF) including Network Slice Selection Function (NSSF) 204, Network Exposure Function (NEF) 206, NF Repository Function (NRF) 208, Policy Control Function (PCF) 210, Unified Data Management (UDM) 212, Application Function (AF) 214, Authentication Server Function (AUSF) 216, Access and Mobility Management Function (AMF) 218, Session Management Function (SMF) 220; User Plane Function (UPF) 226, and various other functions (not shown) such as Unstructured Data Storage Function (UDSF); Unified Data Repository (UDR); 5G-Equipment Identity Register (5G-EIR); and/or Security Edge Protection Proxy (SEPP).

The AMF 218 may include the following functionality (some or all of the AMF functionalities may be supported in one or more instances of an AMF): termination of RAN control plane (CP) interface (N2); termination of non-access stratum (NAS) (e.g., N1), NAS ciphering and integrity protection; registration management; connection management; reachability management; mobility management; lawful intercept (for AMF events and interface to L1 system); transport for session management (SM) messages between UE 222 and SMF 220; transparent proxy for routing SM messages; access authentication; access authorization; transport for short message service (SMS) messages between UE 222 and a SMS function (SMSF); Security Anchor Functionality (SEAF); Security Context Management (SCM), which receives a key from the SEAF that it uses to derive access-network specific keys; Location Services management for regulatory services; transport for Location Services messages between UE 222 and a location management function (LMF) as well as between RAN 224 and LMF; evolved packet service (EPS) bearer ID allocation for interworking with EPS; and/or UE mobility event notification; and/or other functionality.

SMF 220 may support: session management (e.g., session establishment, modification, and release), UE IP address allocation and management, dynamic host configuration protocol (DHCP) functions, termination of NAS signaling related to session management, downlink data notification, and traffic steering configuration for UPF for proper traffic routing. UPF 226 may support: packet routing and forwarding, packet inspection, quality-of-service (QoS) handling, external protocol data unit (PDU) session point of interconnect to DN 228, and anchor point for intra-RAT and inter-RAT mobility. PCF 210 may support: unified policy framework, providing policy rules to control protocol functions, and/or access subscription information for policy decisions in UDR. AUSF 216 may acts as an authentication server. UDM 212 may support: generation of Authentication and Key Agreement (AKA) credentials, user identification handling, access authorization, and subscription management. NRF 208 may support: service discovery function, and maintain NF profile and available NF instances. NSSF may support: selecting of the Network Slice instances to serve the UE 222, determining the allowed network slice selection assistance information (NSSAI), and/or determining the AMF set to be used to serve the UE 222.

NEF 206 may support: exposure of capabilities and events, secure provision of information from external application to 3 GPP network, translation of internal/external information. AF 214 may support: application influence on traffic routing, accessing NEF 206, and/or interaction with policy framework for policy control.

As shown in FIG. 2, the CN 200 may be in communication with the AS 202, UE 222, RAN 224, and DN 228. In some examples, the CN 200 communicates with the external AS 202 via the NEF 206 and/or AF 214. As discussed in more detail herein, the NEF 206 and/or AF 214 may receive signaling from the AS 202 indicating the traffic burst factor or information related to the traffic burst factor. In some examples, the CN 200 communicates with the RAN 224 (e.g., such as the BS 110a in the wireless communication network 100 illustrated in FIG. 1) and/or the UE 222 (e.g., such as the UE 120a in the wireless communication network 100 illustrated in FIG. 1) via the AMF 218. As discussed in more detail herein AMF 218 may provide the traffic burst factor or information related to the traffic burst factor to the RAN 224. As also discussed in more detail below, the CN 200 and/or the RAN 224 may utilize the traffic burst factor for admission control and/or resource allocation.

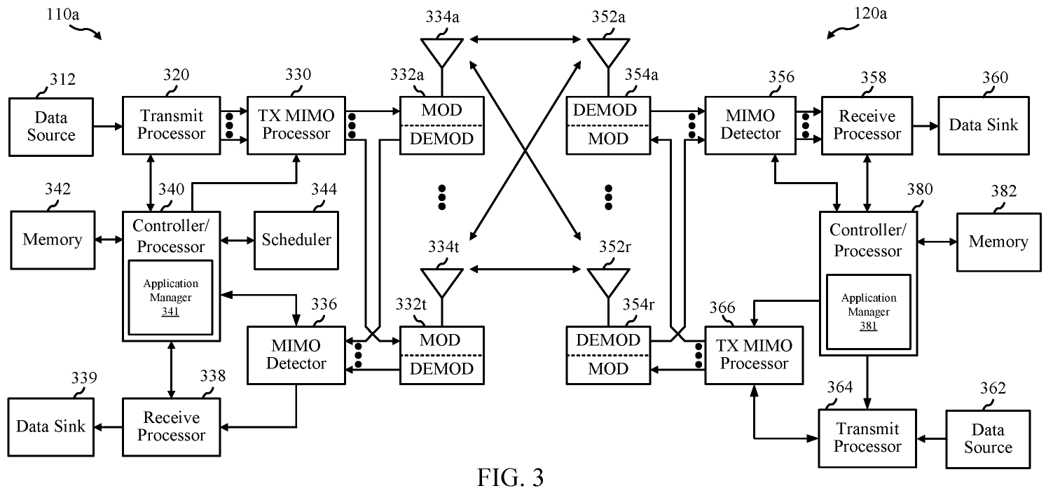

FIG. 3 illustrates example components of BS 110a and UE 120a (e.g., in the wireless communication network 100 of FIG. 1), which may be used to implement aspects of the present disclosure.

At the BS 110a, a transmit processor 320 may receive data from a data source 312 and control information from a controller/processor 340. The control information may be for the physical broadcast channel (PBCH), physical control format indicator channel (PCFICH), physical hybrid ARQ indicator channel (PHICH), PDCCH, group common PDCCH (GC PDCCH), etc. The data may be for the PDSCH, etc. The processor 320 may process (e.g., encode and symbol map) the data and control information to obtain data symbols and control symbols, respectively. The transmit processor 1220 may also generate reference symbols, such as for the primary synchronization signal (PSS), secondary synchronization signal (SSS), and channel state information reference signal (CSI-RS). A transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) 332a-332t. Each modulator 332 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 332a-332t may be transmitted via the antennas 334a-334t, respectively.

At the UE 120a, the antennas 352a-352r may receive the downlink signals from the BS 110a and may provide received signals to the demodulators (DEMODs) in transceivers 354a-354r, respectively. Each demodulator 354 may condition (e.g., filter, amplify, downconvert, and digitize) a respective received signal to obtain input samples. Each demodulator may further process the input samples (e.g., for OFDM, etc.) to obtain received symbols. A MIMO detector 356 may obtain received symbols from all the demodulators 354a-354r, perform MIMO detection on the received symbols if applicable, and provide detected symbols. A receive processor 358 may process (e.g., demodulate, deinterleave, and decode) the detected symbols, provide decoded data for the UE 120a to a data sink 360, and provide decoded control information to a controller/processor 380.

On the uplink, at UE 120a, a transmit processor 364 may receive and process data (e.g., for the physical uplink shared channel (PUSCH)) from a data source 362 and control information (e.g., for the physical uplink control channel (PUCCH) from the controller/processor 380. The transmit processor 364 may also generate reference symbols for a reference signal (e.g., for the sounding reference signal (SRS)). The symbols from the transmit processor 364 may be precoded by a TX MIMO processor 366 if applicable, further processed by the demodulators in transceivers 354a-354r (e.g., for SC-FDM, etc.), and transmitted to the BS 110a. At the BS 110a, the uplink signals from the UE 120a may be received by the antennas 334, processed by the modulators 332, detected by a MIMO detector 336 if applicable, and further processed by a receive processor 338 to obtain decoded data and control information sent by the UE 120a. The receive processor 338 may provide the decoded data to a data sink 339 and the decoded control information to the controller/processor 340.

The memories 342 and 382 may store data and program codes for BS 110a and UE 120a, respectively. A scheduler 344 may schedule UEs for data transmission on the downlink and/or uplink.

The controller/processor 380 and/or other processors and modules at the UE 120a may perform or direct the execution of processes for the techniques described herein. For example, as shown in FIG. 3, the controller/processor 340 of the BS 110a has an application manager 341 that may be configured for obtaining a traffic burst factor associated with a minimum link rate and a latency at which coverage is provided for a traffic flow for at least one service and utilizing the traffic burst factor for admission control, resource allocation, or both, according to aspects described herein.

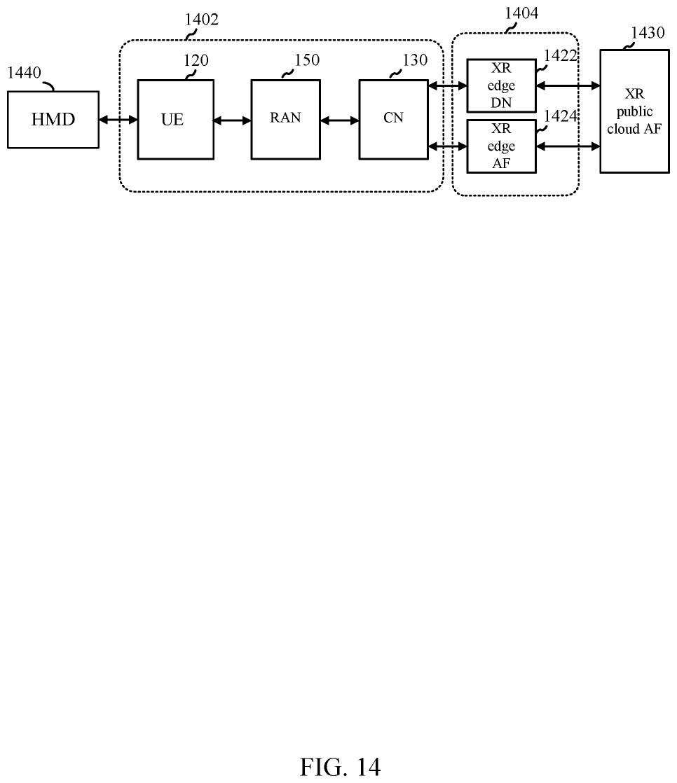

Antennas 352, processors 366, 358, 364, and/or controller/processor 380 of the UE 120a and/or antennas 334, processors 320, 330, 338, and/or controller/processor 340 of the BS 110a may be used to perform the various techniques and methods described herein. For example, as shown in FIG. 3, the controller/processor 340 of the BS 110a has an application manager 341 that may be configured for enhancing file-based service such as XR, according to aspects described herein. For example, as shown in FIG. 14, the controller/processor 1480 of the UE 120 has an application manager that may be configured for enhancing file-based services such as XR, according to aspects described herein.

NR may utilize orthogonal frequency division multiplexing (OFDM) with a cyclic prefix (CP) on the uplink and downlink. NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, etc.).

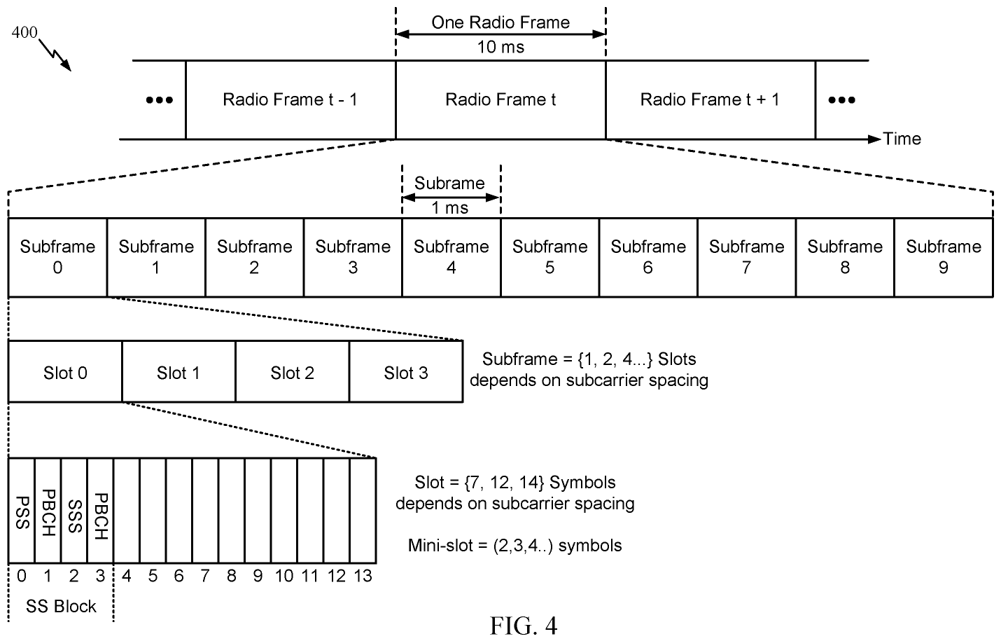

FIG. 4 is a diagram showing an example of a frame format 400 for NR. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots (e.g., 1, 2, 4, 8, 16, . . . slots) depending on the SCS. Each slot may include a variable number of symbol periods (e.g., 7, 12, or 14 symbols) depending on the SCS. The symbol periods in each slot may be assigned indices. A mini-slot, which may be referred to as a sub-slot structure, refers to a transmit time interval having a duration less than a slot (e.g., 2, 3, or 4 symbols). Each symbol in a slot may indicate a link direction (e.g., DL, UL, or flexible) for data transmission and the link direction for each subframe may be dynamically switched. The link directions may be based on the slot format. Each slot may include DL/UL data as well as DL/UL control information.

A communication system, such as the wireless communication network 100 (e.g., a RAN 224), may provide communication services to a UE (e.g., the UE 222; UE 120a). The traffic requirements for a service can be summarized via a set of parameters (e.g., quality-of-service (QoS) parameters) and associated with the traffic flow that supports that service. The parameters may include the packet error rate (PER), packet delay budget (PDB), and/or a guaranteed bit rate (GBR). The PER may be the ratio, in percent, of successfully received packets. For example, the PER may define an upper bound for the rate of protocol data units (PDUs), such as Internet protocol (IP) packets, that have been processed by the sender of a link layer protocol (e.g., RLC in RAN of a 3GPP access) but that are not successfully delivered by the corresponding receiver to the upper layer (e.g. PDCP in RAN of a 3GPP access). Thus, the PER may define an upper bound for a rate of non-congestion related packet losses. PDB may defined as an upper bound for the time that a packet may be delayed between the UE (e.g., UE 222) and the UPF (e.g., UPF 226) on the CN side. The GBR may indicate the bandwidth (bit rate) to be guaranteed by the network.

A resource type may determine if dedicated network resources related to a QoS flow-level guaranteed flow bit rate (GFBR) value are permanently allocated (e.g., by an admission control function in a radio base station), while a non-GBR QoS flow may be pre-authorized through static policy and charging control. A GBR QoS flow may use either the GBR resource type or the Delay-critical GBR resource type. For traffic flows of type “Delay critical GBR” (e.g., for URLLC traffic flows), a parameter called Maximum Data Burst Volume (MDBV) is specified to describe the traffic burst. The MDBV denotes the largest amount of data that the 5G-AN is required to serve within a period of 5G-AN PDB (e.g., 5G-AN part of the PDB). The MDBV may be signaled together with a standardized indicator value (e.g., 5QI) to the (R)AN (e.g., RAN 224), and if it is received, it shall be used instead of the default value.

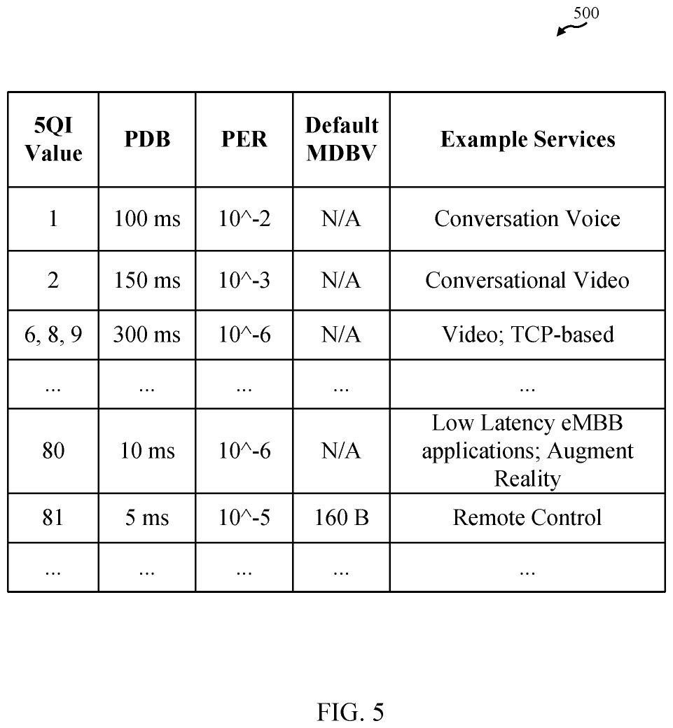

The Table 500 in FIG. 5 shows example QoS parameters that may be configured for various services. In some examples, the conversational voice service, the conversational video service (e.g., such as live streaming), and the video service (e.g., such as buffered streaming) and/or TCP-based service (e.g., such as the World Wide Web, email, chat, ftp, p2p file sharing, progressive video, etc.) may be associated with eMBB service. In some examples, remote control service (e.g., a UE being operated remotely, either by a human or a computer, such as a remote driver or a V2X application to operate a remote vehicle with no driver or a remote vehicle located in a dangerous environment) may be associated with URLCC. In some examples, the low-latency applications may be associated with XR service. In the use cases like VR and interactive conversation, the latency requirements include the latencies at the application layer (e.g., codecs), which could be specified outside of 3GPP. The QoS parameters and services shown in the Table 500 in FIG. 5 are merely illustrative, and various other QoS parameters and services may be specified.

At high PDB values (e.g., equal to or exceeding 100 ms), the burst of a traffic over the PDB range may be closely approximated by the GBR*PDB. For some traffic flows, measured over every PDB, the percentile of times when the burst exceeds GBR*PDB is small relative to the PER. Dropping packets of such bursts will have negligible effect on the PER of the traffic. Thus, for such traffic flows it may not be important to convey the size of the traffic burst. However, for traffic flows at low PDB and low PER values, the volume of traffic that the 5G system handles can be much higher than GBR*PDB. In this case, it is useful to describe the traffic burst.

As mentioned above, the MDBV is specified for the traffic flows of type “Delay critical GBR” which are expected to handle traffic of low throughput. Thus, in some cases the range of values for MDBV is capped at 4095 Bytes (e.g., when signaled on 5G network interfaces). Even with a PDB of 1 ms, the throughout cap of 4095 Bytes implies that the maximum throughput on that flow can be no more than 4095 Bytes/ms (i.e., around 32.76 Mbps). The supported throughput may be even lower on traffic flows with larger PDB values. However, for certain services, such as XR services (e.g., AR, VR, cloud gaming), the throughput requirements (e.g., up to 250 Mbps) and PDB requirements (e.g., 25 ms) can be higher.

Signaling the burst throughput value (e.g., defined as MDBV/PDB) could convey a range of MDBV values with a smaller number of bits. In addition, conveying the burst throughput as a multiple of GBR would further reduce the number of bits.

In certain aspects, the definition of the MDBV may not explicitly account for the corresponding PER. For example, among the traffic bursts over every PDB range, a percentile of traffic bursts below the PER need not be served by the 5G system and can be ignored when specifying the largest traffic burst that the 5G system is required to serve.

Accordingly, certain aspects provide techniques for efficiently providing traffic burst information to a communication network.

### Example Traffic Burst Awareness

A new parameter called the burst factor (or Burst-Factor) may be defined to describe the traffic bursts generated by a service on a given traffic flow. The burst factor may be particularly useful for handling traffic from services with high throughput requirements, low packet delay budget (PDB) values, and/or high reliability (e.g., low packet error rate (PER) values) requirements, such as XR services.

In some examples, the burst factor is associated with the way traffic is generated for a traffic flow associated with the service and/or application. For example, the application designer(s) may design the traffic shaping. For example, the traffic associated with an application may be highly bursty (e.g., with large packet/file sizes). The burstiness may impact the traffic pattern for the service, such as the arrival pattern.

The traffic burst factor may be defined as a multiplicative factor for the guaranteed bit rate (GBR) associated with a traffic flow (e.g., uplink and/or downlink traffic flow) such that the product of the burst factor times the GBR is the minimum link rate (e.g., minimum constant link rate) for service coverage. Service coverage is said to be met when the number of packets lost or delayed by more than the PDB associated with the traffic flow is smaller than the PER associated with the traffic flow. In some examples, the burst factor may be different for uplink traffic flows and downlink traffic flows.

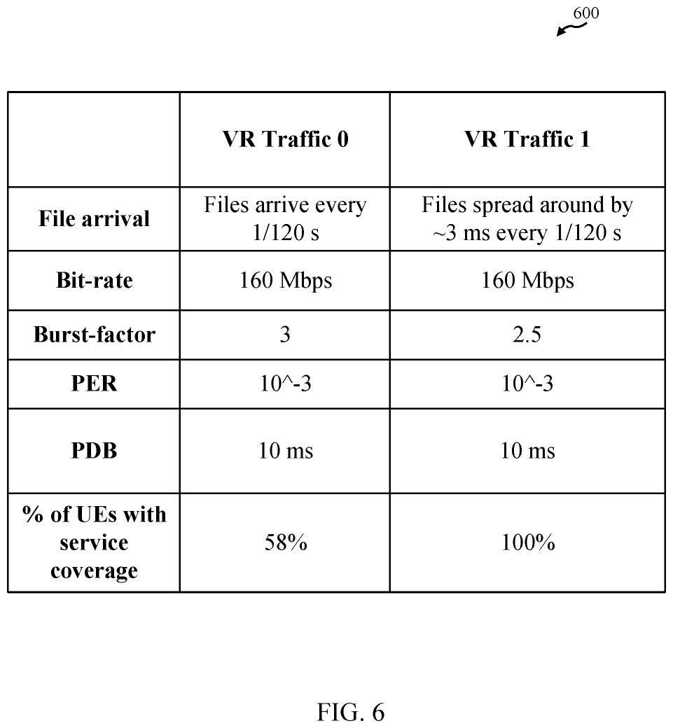

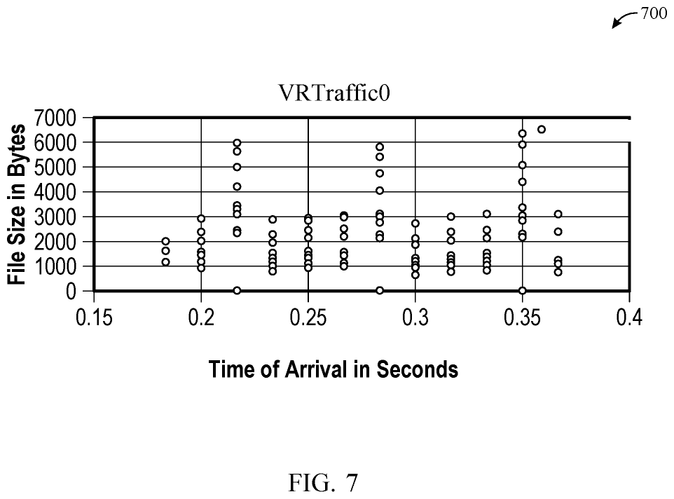

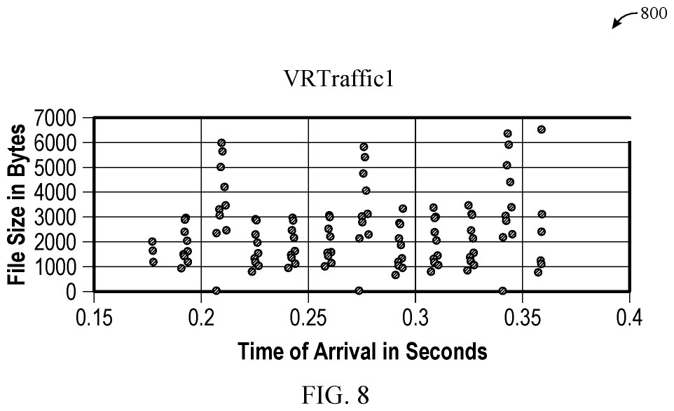

The burst factor is associated with the coverage and capacity for the service in the wireless network. For example, different traffic flows associated with different traffic burst factors may achieve different levels of service coverage. Table 600 in FIG. 6 shows example QoS parameters for two traffic flows for virtual reality (VR) services with different burst factors, in accordance with certain aspects of the present disclosure. As shown in the Table 600, the VR Traffic 0 and the VR Traffic 1 have the same bit-rate, PER, and PDB requirements, but different burst-factors. The burst factors of the two traffic flows are different because the file arrival patterns are different as shown in Table 600 and in the chart 700 in FIG. 7 showing the corresponding example arrival pattern for VR Traffic 0 and the chart 800 showing the corresponding example arrival pattern for the VR Traffic 1 in FIG. 8. As shown, the percentage of UEs with service coverage for the example VR Traffic 0 with the higher burst factor (3) is lower (58%) as compared to percentage of UEs with service coverage (100%) for the example VR Traffic 1 with the lower burst-factor (2.5).

In an illustrative example, a UE (e.g., such as the UE 222), such as a smart phone may operate in a wireless network such as a 5G network (e.g., such as the RAN 224 and CN 200). A user may download an application (“app”) on the user's phone (or the app is preconfigured on the phone, etc.). The application may be provided by an application provider external to the 5G network. For example, the application may be hosted on an application server (e.g., such as the AS 202). The 5G network may provide a link between the phone and the application server. For example, traffic flow for an application on the UE may occur over the link, and the traffic flow is associated with a burst factor. In order to determine how and whether to provide the service to the UE for the application, it may be helpful for the network (or operator) to know the traffic burst factor associated with the application. Accordingly, aspects of the present disclosure provide techniques for providing a burst factor to the communication system.

The present invention proposes that the traffic burst information be conveyed to a wireless network via the burst-factor. The burst-factor is defined as described above: as the multiplicative factor for a constant link rate that is required for service coverage. The traffic burst factor may be defined as a multiplicative factor for the GBR associated with a traffic flow such that the product of the burst factor times the GBR is the minimum link rate (e.g., minimum constant link rate) for service coverage. Unlike the MDBV, the burst factor may be provided for services other than those that are configured for “Delay Critical GBR”; the burst factor may account for the corresponding PER; the burst factor may be for larger packet sizes, the burst factor may indicate a range of values; the burst factor may indicate larger than 32.67 Mbps throughput (e.g., up to 250 Mbps); the burst factor may be specified as bits versus bytes; and/or the burst factor may be defined based on the burst rate versus the burst volume.

According to certain aspects, the burst factor can be calculated. In some examples, the burst factor may be calculated at the AS, a CN entity, and/or a network entity in the RAN. In some example, if calculated at the CN or the RAN entity, the AS may provide information related to the burst factor to the CN entity and/or the RAN entity, and the CN and/or the RAN entity can calculate the burst factor using the information provided by the AS.

In some examples, the traffic burst factor can be explicitly calculated by simulating that traffic at a link rate (e.g., in a single queue system of constant link rate) and determining the minimum constant link rate at which the traffic service requirements are met (e.g., the PER is below a threshold). In some examples, the simulation may be done offline by the application provider and/or the network operator.

According to certain aspects, the burst factor can be approximated by monitoring the burst-rates over several time durations of the traffic, and looking at how much volume is to be served in the time durations. The percentile of highest burst-rates with percentile equal to PER in percentage can then be eliminated. Then the multiplication factor can be calculated by which the highest of the remaining burst rates exceeds the average bit-rate of the traffic. In some examples, the time durations for calculation of the burst-rates in the above description can be the PDB.

The application provider may store the calculated burst factor in a database. In some examples, additionally or alternatively, the application provider (e.g., via the AS 202) may signal the burst factor to the CN (e.g., CN 200). In some examples, additionally or alternatively, the application provider (e.g., via the AS 202) may signal the information related to the burst factor to the CN (e.g., CN 200), such as the traffic data traces (e.g., traffic pattern). In some examples, the AS 202 signals the information and/or burst factor to the AF 214 via the NEF 206. The information and/or burst factor may be stored in a database in the CN 200, the RAN 224, and/or an external database. In some examples, the application provider provides the information and/or the burst factor the operator of the network offline, and the information and/or burst factor is stored in the database. In some examples, the AF 214 may provide the information and/or the burst factor to one or other network entities in the CN 200. In some examples, the CN 200 may provide the information and/or the burst factor to the RAN 224. For example, the CN 200 may signal the information and/or the burst factor to the RAN 224 via the AMF 218 with the N2 interface. In some examples, the information and/or the burst factor is provided to one or more BSs in the RAN 224. In some examples, BSs in the RAN 224 may signal the information and/or the burst factor with other BSs in the RAN 224 via a backhaul interface (e.g., an Xn interface).

According to certain aspects, the signalling of the information and/or the burst factor between any of the entities may be conveyed via new messages, adding additional fields to existing messages, and/or reinterpreting existing fields of existing messages. In some examples, the burst factor can be conveyed by reinterpreting MDBV bits (e.g., bits of the existing MDBV field). For example, the MDBV bits may be interpreted differently when for a traffic flow for one service (e.g., such as for XR service) than a traffic flow for another service (e.g., URLLC). In some examples, the burst factor can be conveyed by defining MDBV=burst factor*GBR*PDB, and increasing the range of values for the MDBV field. In some examples, MDBV may be exchanged between AF 214 and the NEF 206, between the NEF 206 and the PCF 210, between the PCF 210 and AMF 218, and between the AMF 218 and the RAN 224.

According to certain aspects, the wireless network (e.g., the RAN 224) can use the burst factor for admission control (e.g., an admission controller at a BS or another entity in the RAN 224). The admission controller may use the burst factor to determine if the traffic QoS requirements can be successfully met or not. For example, the admission controller may use the burst factor to determine whether the link rate or expected link rate of the UE (e.g., UE 222) is higher than the burst factor*GBR. The admission controller may determine whether to admit or deny a traffic flow for a service based on the determination.

According to certain aspects, the wireless network (e.g., the RAN 224) can use the burst factor for resource allocation (e.g., a scheduler at a BS or another entity in the RAN 224). In some examples, the RAN 224 may determine the pattern of traffic for UEs. In some examples, the scheduler can learn the occurrence pattern of the traffic bursts and use the burst factor to estimate resource allocation required over time. If the pattern of occurrence of the burst is explicitly conveyed to the 5G system, and the scheduler is made aware of it, then the scheduler can further infer the overlap of bursts of multiple users. For example, the scheduler may know the periodicity at which bursts arrive. This information can be used in look-ahead scheduler resource planning. If the burst overlaps result in resource allocation that is infeasible, then this information can be fed back to admission control module to assist in admission control decisions. In an example, if the bursts for UEs overlap, and based on the burst factor (e.g., if the burst factor is large), then the service may not be admitted for the colliding UEs. If the UEs are already admitted, then the scheduler may use the information for resource planning.

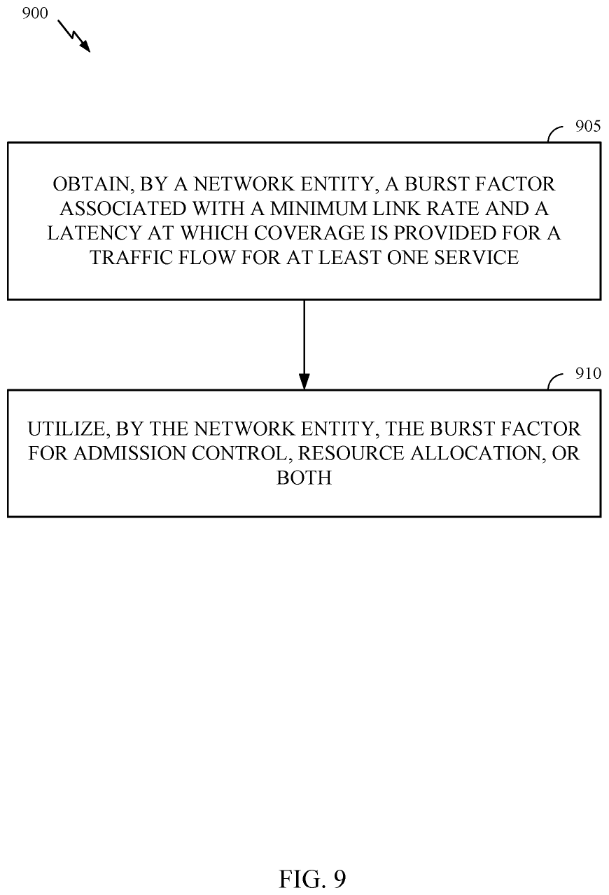

FIG. 9 is a flow diagram illustrating example operations 900 for wireless communication, in accordance with certain aspects of the present disclosure. The operations 900 may be performed by a network entity, for example, an entity in a core network and/or RAN.

The operations 900 may begin, at 905, by obtaining a burst factor associated with a minimum link rate and a latency at which coverage is provided for a traffic flow for at least one service. In some examples, the coverage is provided when the number of packets lost or delayed by more than a PDB is less than a PER. In some examples, the at least one service is AR, VR, cloud gaming, or a combination thereof. In some examples, a burst throughput of the traffic flow for at least one service is greater than the GBR. In some examples, a throughput of the traffic flow for at least one service is greater than 32.76 Mbps.

In some examples, the burst factor is a QoS parameter associated with a traffic burst of the traffic flow for the at least one service. In some examples, the burst factor is associated with a size of one or more traffic bursts for the traffic flow, an arrival pattern of the one or more traffic bursts for the traffic flow, or a combination thereof.

In some examples, obtaining the burst factor includes determining the burst factor. In some examples, the operations 900 include receiving, at a BS in a network, information from a network entity in the network, and the BS determines the burst factor based on the information. In some examples, the operations 900 include receiving, at a network entity in a network, information from an application server, wherein the network entity determines the burst factor based on the information. In some examples, determining the burst factor includes simulating or monitoring a traffic flow on a communication link of constant link rate; and determining a minimum constant link rate at which one or more QoS parameters are met for the traffic flow. In some examples, determining the burst factor includes monitoring burst-rates over a plurality of durations; excluding one or more of the monitored burst-rates based on a PER; and calculating the burst factor based on a multiplication factor at which a highest remaining burst-rate exceeds an average bit-rate of the traffic flow. In some examples, the durations are PDBs.

In some examples, obtaining the burst factor includes receiving signaling indicating the burst factor. In some examples, the signaling indicating the burst factor is received at a network entity from an application server, an AF, or another network entity. In some examples, the signaling indicating the burst factor is received at a BS from a network entity or another BS. In some examples, the network entity is an AMF or policy and charging control (PCC). In some examples, the burst factor is signaled via a new message, a new field in an existing message, an interpretation of an existing field, or a combination thereof. In some examples, the burst factor is signaled via one or more bits of a MDBV field. In some examples, the MBDV comprises a product of the burst factor, a GBR, and a PDB.

At 910, the network entity utilizes the burst factor for admission control, resource allocation, or both.

In some examples, utilizing the burst factor for admission control includes performing admission control using the burst factor, providing the burst factor to an admission control device, or a combination thereof. In some examples, utilizing the burst factor for admission control includes receiving a request for the at least one service for a UE; determining whether a QoS for the at least one service can be met based on the burst factor; and determining whether to admit the at least one service for the UE based on the determination. In some examples, determining whether the QoS for the at least one service can be met based on the burst factor includes determining an expected rate of a link with the UE; and determining whether the expected rate of the link with the UE is higher than a product of the burst factor, a GBR, and a PDB.

In some examples, utilizing the burst factor for resource allocation includes performing scheduling resources based on the burst factor, providing the burst factor to a scheduling device, or a combination thereof. In some examples, utilizing the burst factor for resource allocation includes determining a traffic pattern of one or more traffic bursts scheduled or to be scheduled; and allocating one or more resources based on the burst factor. In some examples, determining the traffic pattern of the one or more traffic bursts scheduled or to be scheduled includes receiving an indication of the traffic pattern from an application server, wherein the traffic pattern indicates the one or more traffic bursts for a plurality of UEs; determining one or more overlapping traffic bursts for at least two of the plurality of UEs; and allocating one or more resources based on the overlap. In some examples, the operations 900 further include sending an indication to an admission control device indicating whether a resource allocation can avoid the overlap.

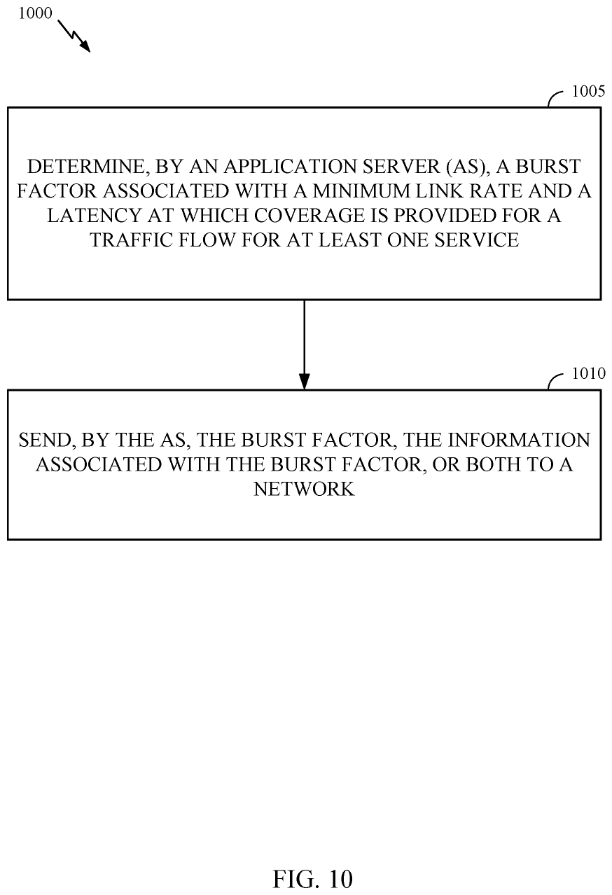

FIG. 10 is a flow diagram illustrating example operations 1000 for wireless communication, in accordance with certain aspects of the present disclosure. The operations 1000 may be performed, for example, by an application server.

The operations 1000 may begin, at 1005, by determining a burst factor associated with a minimum link rate and a latency at which coverage is provided for a traffic flow for at least one service, information associated with the burst factor, or both. In some examples, the coverage is provided when the number of packets lost or delayed by more than a PDB is less than a PER. In some examples, the at least one service is AR, VR, cloud gaming, or a combination thereof. In some examples, a burst throughput of the traffic flow for at least one service is greater than the GBR. In some examples, a throughput of the traffic flow for at least one service is greater than 32.76 Mbps.

In some examples, the burst factor is a QoS parameter associated with a traffic burst of the traffic flow for the at least one service. In some examples, the burst factor is associated with a size of one or more traffic bursts for the traffic flow, an arrival pattern of the one or more traffic bursts for the traffic flow, or a combination thereof.

In some examples, determining the burst factor includes simulating or monitoring a traffic flow on a communication link of constant link rate; and determining a minimum constant link rate at which one or more QoS parameters are met for the traffic flow. In some examples, the determining the burst factor includes monitoring burst-rates over a plurality of durations; excluding one or more of the monitored burst-rates based on a PER; and calculating the burst factor based on a multiplication factor at which a highest remaining burst-rate exceeds an average bit-rate of the traffic flow. In some examples, the durations are PDBs.

At 1010, the application server sends the burst factor, the information associated with the burst factor, or both to a network. In some examples, the burst factor, information associated with the burst factor, or both is sent from an AS to an AF in the network, an AMF in the network, a PCC in the network, another network entity in the network, or a combination thereof. In some examples, the burst factor is signaled via a new message, a new field in an existing message, an interpretation of an existing field, or a combination thereof. In some examples, the burst factor is signaled via one or more bits of a MDBV field. In some examples, the MBDV comprises a product of the burst factor, a GBR, and a PDB.

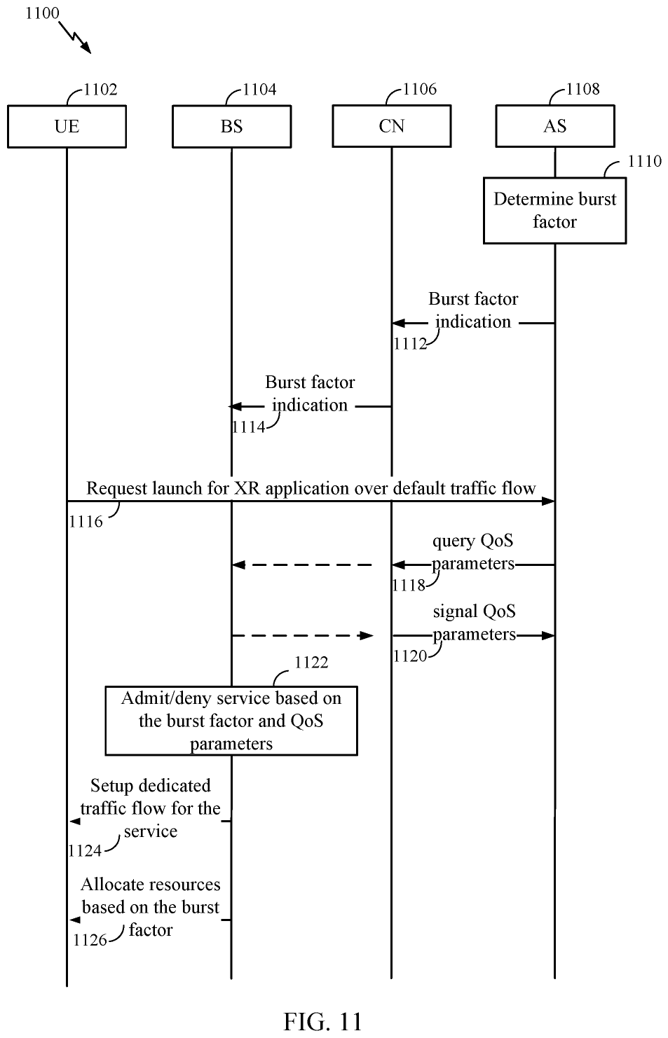

FIG. 11 is an example call flow diagram 1100 illustrating example signaling, in accordance with certain aspects of the present disclosure. In the example call flow 1100, the AS 1108 may determine the burst factor at 1110, in accordance with aspects of the present disclosure. At 1112, the AS 1108 signals the burst factor to the CN 1106, in accordance with certain aspects of the present disclosure. At 1114, the CN 1106 signals the burst factor to the RAN 1104, in accordance with certain aspects of the present disclosure. At 1116, the UE 1102 may request the AS 1108 to launch an application such as an XR application. At 1118, the AS 1108 may query the CN 1106 for the QoS parameters for the service and, at 1120, the CN 1106 may provide the QoS parameters. At 1122, the BS 1104 may admit or deny the traffic flow for the application based, at least in part, on the burst factor and the QoS parameters. At 1124, if the RAN 1104 admits the application, then the BS 1104 sets up a dedicated traffic flow for the service. At 1126, the BS 1104 may perform resource allocation based on the burst factor.

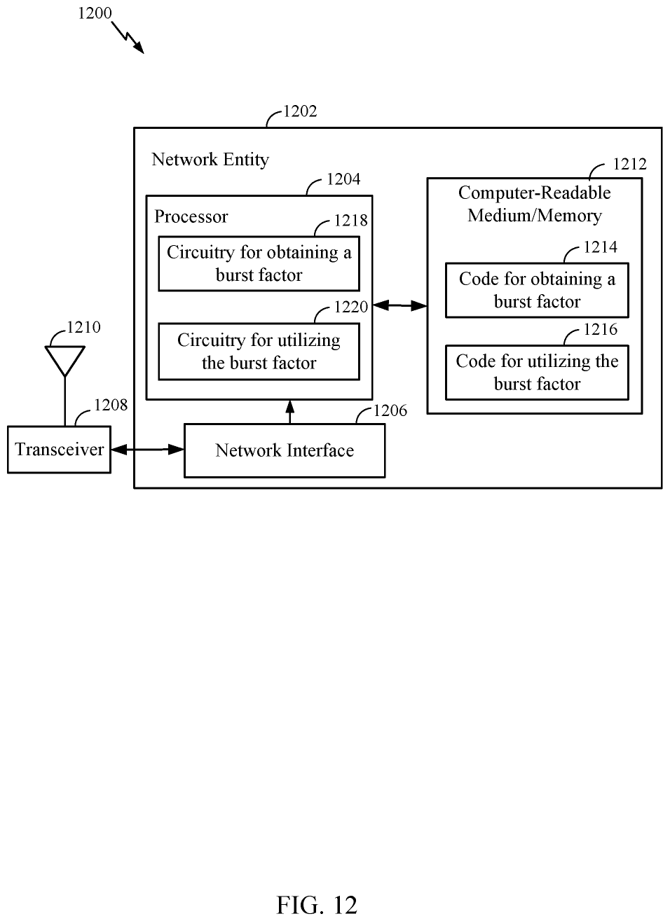

FIG. 12 illustrates example communications device 1200 that may include various components (e.g., corresponding to means-plus-function components) configured to perform operations for the techniques disclosed herein, such as the operations illustrated in FIG. 9. In some examples, the communications device 1200 is a network entity such as a core network entity or a RAN entity (such as a BS). The communications device 1200 includes a processing system 1202 coupled to a transceiver 1208. The transceiver 1208 is configured to transmit and receive signals for the communications device 1200 via an antenna 1210, such as the various signals as described herein. The processing system 1202 may be configured to perform processing functions for the communications device 1200, including processing signals received and/or to be transmitted by the communications device 1200.

The processing system 1202 includes a processor 1204 coupled to a computer-readable medium/memory 1212 via a bus. In certain aspects, the computer-readable medium/memory 1212 is configured to store instructions (e.g., computer-executable code) that when executed by the processor 1204, cause the processor 1204 to perform the operations illustrated in FIG. 9, or other operations for performing the various techniques discussed herein for traffic burst factor awareness in a communication system. In certain aspects, computer-readable medium/memory 1212 stores code 1214 for obtaining a burst factor, in accordance with aspects of the present disclosure; and code 1216 for utilizing the burst factor, in accordance with aspects of the present disclosure. In certain aspects, the processor 1204 has circuitry configured to implement the code stored in the computer-readable medium/memory 1212. The processor 1204 includes circuitry 1218 for obtaining a burst factor; and circuitry 1220 for utilizing the burst factor.

The processor 1204 is coupled with network interface 1206. The network interface 1206 is configured to communicate with a wireless network. For example, the network interface 1206 is configured to receive signaling indicating the burst factor or information associated with the burst factor. The network interface 1206 may be wired and/or wireless and communicate with the wireless network via the transceiver 1208 and antenna 1210 or via a hardwired connection.

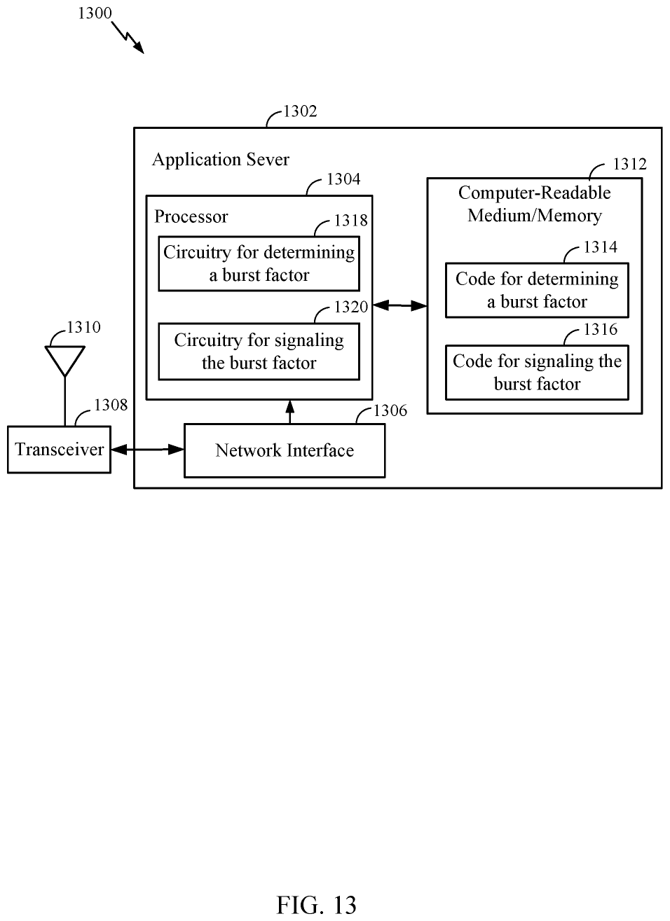

FIG. 13 illustrates example communications device 1300 that may include various components (e.g., corresponding to means-plus-function components) configured to perform operations for the techniques disclosed herein, such as the operations illustrated in FIG. 10. In some examples, the communications device 1300 is an application server. The communications device 1300 includes a processing system 1302 coupled to a transceiver 1308. The transceiver 1308 is configured to transmit and receive signals for the communications device 1300 via an antenna 1310, such as the various signals as described herein. The processing system 1302 may be configured to perform processing functions for the communications device 1300, including processing signals received and/or to be transmitted by the communications device 1300.

The processing system 1302 includes a processor 1304 coupled to a computer-readable medium/memory 1312 via a bus. In certain aspects, the computer-readable medium/memory 1312 is configured to store instructions (e.g., computer-executable code) that when executed by the processor 1304, cause the processor 1304 to perform the operations illustrated in FIG. 10, or other operations for performing the various techniques discussed herein for traffic burst factor awareness in a communication system. In certain aspects, computer-readable medium/memory 1312 stores code 1314 for determining a burst factor, in accordance with aspects of the present disclosure; and code 1316 for signaling the burst factor, in accordance with aspects of the present disclosure. In certain aspects, the processor 1304 has circuitry configured to implement the code stored in the computer-readable medium/memory 1312. The processor 1304 includes circuitry 1318 for determining a burst factor; and circuitry 1320 for signaling the burst factor.

The processor 1304 is coupled with network interface 1306. The network interface 1306 is configured to communicate with a wireless network. For example, the network interface 1306 is configured to receive signaling indicating the burst factor or information associated with the burst factor. The network interface 1306 may be wired and/or wireless and communicate with the wireless network via the transceiver 1308 and antenna 1310 or via a hardwired connection.

### Example File Burst Awareness

FIG. 14 illustrates a wireless communication system for XR. As illustrated, a 5G system 1402 may include a user equipment (UE) 120, a radio access network (RAN) 150, and a core network (CN) 130. In certain aspects, the UE 120 may be associated with a head mount display (HMD) 1440 for virtual reality (VR) or augmented reality (AR) applications. As illustrated, the 5G system 502 may communicate with an edge cloud server 1404, which may include logical entities such as an XR edge data network (DN) 1422 and an XR edge application function (AF) 1424. An edge cloud server generally refers to a cloud server located closer to the UE, allowing communication of data with lower latency for various applications as described herein. For example, CN-to-XR edge server latency may be negligible as compared to the 5G system latency. The edge cloud server 1404 may be associated with an XR public cloud AF 1430, as illustrated. The CN 130 may communicate with the XR edge DN 1422 via an N6 interface (user plane). The CN 130 may communicate with the XR edge AF 1424 via N5 and N33 interfaces. N5 and N33 are interfaces of the XR edge AF 1424 to the 5G system 1402.

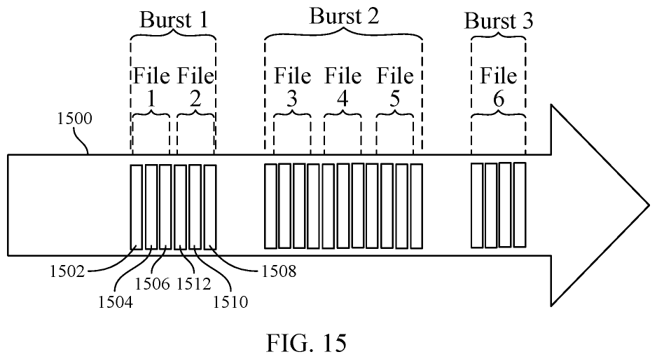

FIG. 15 illustrates a traffic flow 1500 for communication of packets associated with various files. In the illustrated example, packets 1502, 1504, 1506 are associated with a file (e.g., file 1) and packets 1508, 1510, 1512 are associated with another file (e.g., file 2). The files may be sent in multiple bursts. For example, files 1 and 2 are sent in a burst (e.g., burst 1). Similarly, files 3, 4, and 5, are sent in a second burst (e.g., burst 2), and file 6 is sent in a third burst (e.g., burst 3). The traffic flow 1500 may be associated with a guaranteed bit rate (GBR), that may be preconfigured by the RAN 150, and the packets of the traffic flow may be associated with a packet delay budget (PDB) and packet error rate (PER).

A 5G wireless communication system may be aware of only packet-level metrics. In other words, the traffic flow may be specified via packet filters and metrics via PER and PDB. However, XR applications might specify metrics on a group of packets (e.g., a file). For instance, the XR application may specify a file error rate (FER) rather than PER. Moreover, the reliability requirements of files may vary. For example, the reliability requirements may differ for intra-coded frames (I-frames) versus predicted frames (P-frames) on a XR traffic flow. In some cases, the XR application may specify a policy with regards to file handling. For instance, the XR application may specify that a file may be used only if all packets of a file are received, or that a contiguous stream of packets up to the first packet in error may be used.

When file-level metrics such as FER are translated to packet-level metrics such as PER for the 5G system, information may be lost, resulting in inaccurate handling of file level requirements of the application. As an example, the network settings for UE power savings (e.g., connected mode discontinuous reception (CDRX) parameters or PDCCH skipping) may not take into account periodic bursts of XR traffic or bursts that vary in duration, resulting in excessive power consumption by the UE during transmission or reception of XR traffic. Furthermore, it may be difficult for the network to learn the traffic burst pattern if a burst spread (e.g., a duration of a burst) varies across bursts.

Aspects of the present disclosure provide techniques for file-level metrics, such as burst parameters associated with bursts of XR traffic, that may be used for XR applications. In some example, the RAN may receive or determine one or more burst parameters associated with bursts of file transmissions (e.g., downlink XR traffic bursts or uplink XR traffic bursts), for example as discussed above, and set sleep mode parameters for the UE based on the one or more burst parameters. The sleep mode parameters may enable the UE to reduce its power consumption while receiving or transmitting the bursts of file transmissions (e.g., XR traffic). For instance, the sleep mode parameters may indicate a sleep duration (e.g., when the UE is not monitoring its receiver for signals) associated with DRX (e.g., CDRX) cycles or a duration to monitor and/or skip monitoring downlink control signaling (e.g., PDCCH). As a result of the file-burst aware sleep mode described herein, the UE may be capable of supporting XR traffic communications for a longer period of time.

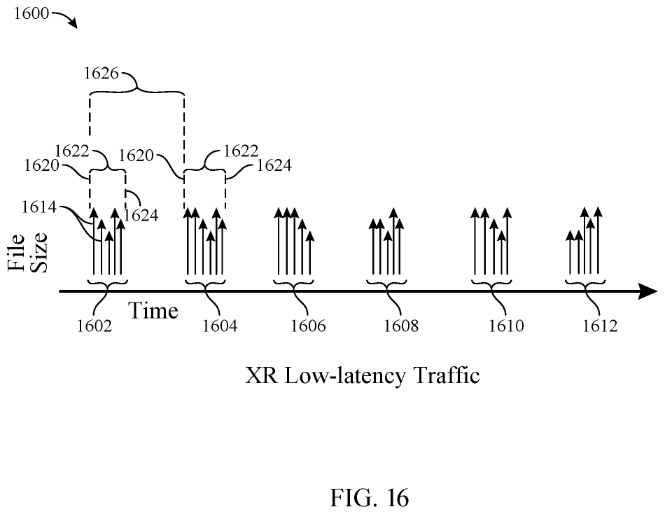

FIG. 16 illustrates an example XR traffic flow 1600 for communication of files, in accordance with certain aspects of the present disclosure. As shown, the traffic flow 1600 may be transmitted via bursts 1602, 1604, 1606, 1608, 1610, 1612, each including one or more files 1614, which may include multiple packets as previously described herein. Each of the bursts 1602, 1604, 1606, 1608, 1610, 1612 has a burst start time 1620, burst spread 1622, and burst end time 1624. The burst spread 1622 is a duration of a burst from the burst start time 1620 to the burst end time 1624.

The bursts 1602, 1604, 1606, 1608, 1610, 1612 may be transmitted on a periodic basis, for example, according to a burst period 1626. The burst period 1626 is the duration between burst start times 1620 of consecutive bursts (e.g., between bursts 1602 and 1604). The burst spread 1622 may be constant or vary from burst to burst. For example, the burst spread 1622 of the second burst 1604 may be greater than the burst spread 1622 of the first burst 1602.

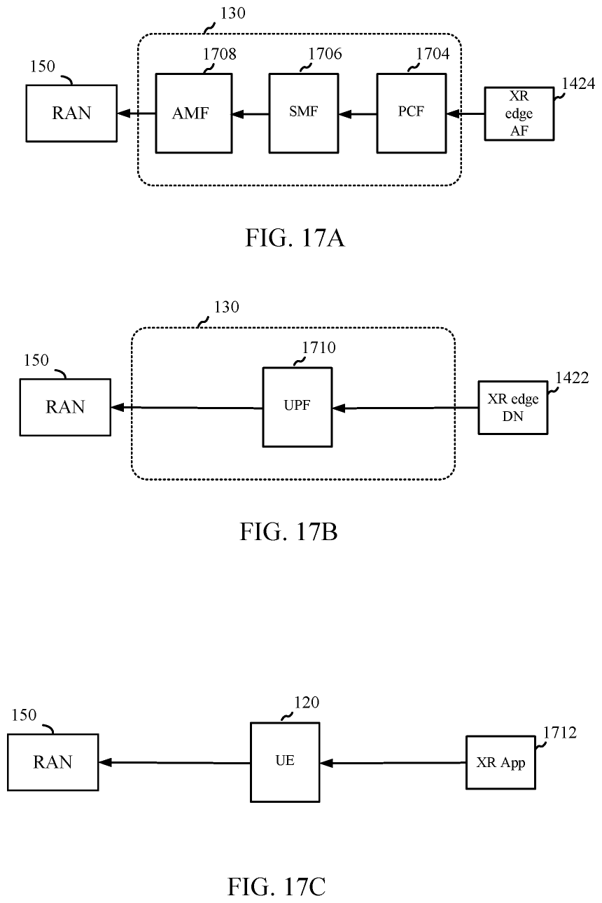

FIG. 17A illustrates an example communication flow of the burst parameters from the XR edge AF 1424 to the RAN 150, in accordance with certain aspects of the present disclosure. As shown, the XR edge 1424 of a server entity (e.g., the edge cloud server 1430) may send one or more burst parameters (e.g., a burst start time, burst spread, or burst end time) to the RAN 150 via logical functions of the CN 130 including a policy control function (PCF) 1704, a session management function (SMF) 1706, and an access and mobility management function (AMF) 1708. For example, a constant burst spread may be sent to the RAN 150 from the XR edge AF 1424 to the PCF 1704, from the PCF 1704 to the SMF 1706, from the SMF 1706 to the AMF 1708, and from the AMF 1708 to the RAN 150.

FIG. 17B illustrates another example communication flow of the burst parameters from the XR edge DN 1422 to the RAN 150, in accordance with certain aspects of the present disclosure. As shown, the XR edge DN 1422 of a server entity (e.g., the edge cloud server 1430) may send one or more burst parameters (e.g., a burst start time, burst spread, or burst end time) to the CN 130 having a logical function, a user plane function 1410, which may forward the burst parameters to the RAN 150. For example, if the burst spread for a traffic flow varies across bursts, the burst start time and burst end time may be conveyed to the RAN 150 via a data plane such as through the UPF 1710 of the CN 130.

FIG. 17C illustrates an example communication flow of the burst parameters from the UE 120 to the RAN 150, in accordance with certain aspects of the present disclosure. As shown, the UE 120 may obtain one or more burst parameters (e.g., a burst start time, burst spread, or burst end time) from an XR application client 1712 (e.g., an XR application), and the UE 120 may transmit the one or more burst parameters to the RAN 150.

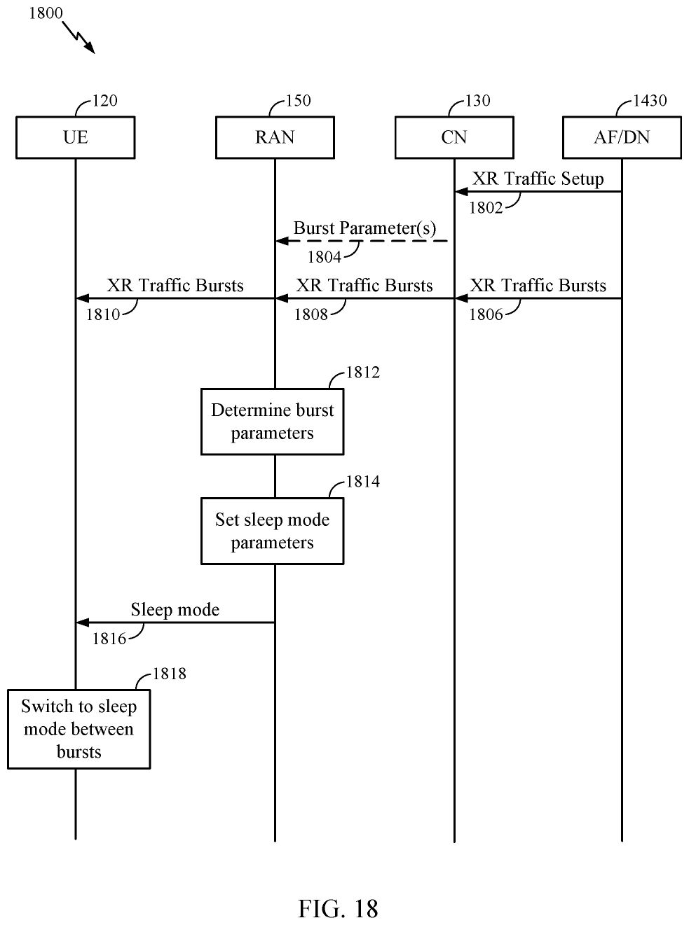

FIG. 18 is a call-flow diagram illustrating example operations 1800 for enabling file burst awareness of downlink traffic, in accordance with certain aspects of the present disclosure. As shown, at 1802, the server entity (AF/DN) 1430 may setup a traffic flow (e.g., XR traffic flow) session with the core network 130 to communicate bursts of traffic to the UE 120. The traffic flow setup messages may include one or more burst parameters, and at 1804, the CN 130 may send the one or more burst parameters to the RAN 150 as described herein with respect to FIGS. 17A and 17B. At 1806, the server entity 1430 may communicate the traffic bursts (e.g., the traffic flow 1500 of bursts as depicted in FIG. 15) to the CN 130, which may forward the traffic bursts to the RAN 150 at 1808. At 1810, the RAN 150 may transmit the traffic bursts to the UE 120. The transmission of the traffic bursts may continue through the remainder of the operations 1800.

At 1812, the RAN 150 may determine the one or more burst parameters from the traffic bursts themselves or from the parameters received at 1804. In certain aspects, the RAN 150 may determine the burst start times if the bursts are periodic and determine the burst spread if the burst spreads are constant across the bursts. In other aspects, the RAN 150 may receive an indication of the burst spread from the CN 130 at 1804. In aspects, the RAN 150 may receive an indication of the burst start time and the burst spread from the CN 130 at 1804. In other cases, the RAN 150 may receive an indication of the burst start time and burst end time from the server entity 1430 at 1804.

At 1814, the RAN 150 may set sleep mode parameters for the UE 120 in accordance with the burst parameters and adjust the sleep mode parameters if the burst start times and/or burst spreads vary across bursts. At 1816, the RAN 150 may signal an indication of the sleep mode parameters (e.g., a configuration for sleep mode cycles and/or a command to enter a sleep or low power mode) to the UE 120. At 1818, the UE 120 may switch to a sleep mode between bursts in accordance with the sleep mode parameters.

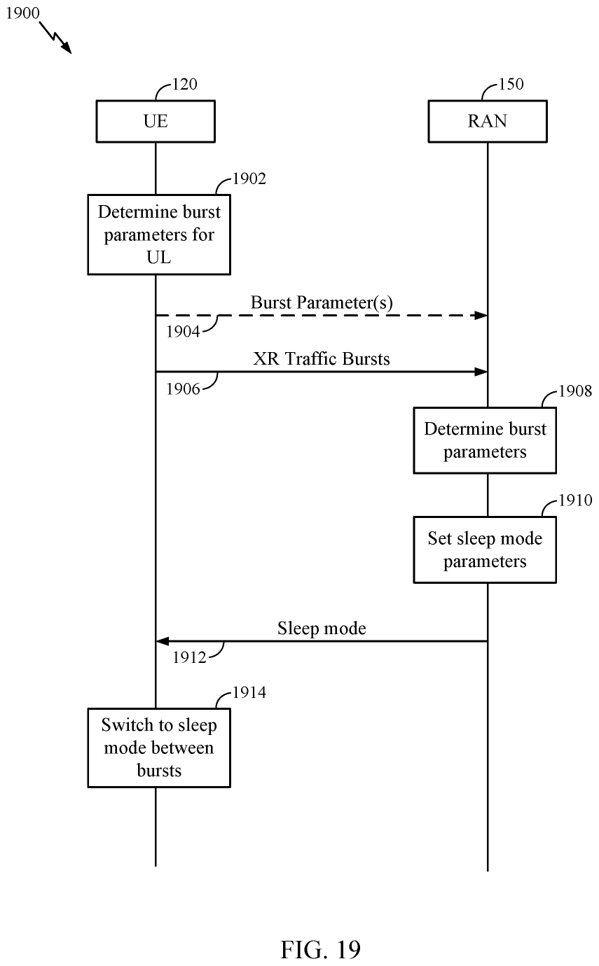

FIG. 19 is a call-flow diagram illustrating example operations 1900 for enabling file burst awareness of uplink traffic, in accordance with certain aspects of the present disclosure. As shown, at 1902, the UE 120 may determine one or more burst parameters (e.g., a burst start time, burst spread, or burst end time) associated with bursts of traffic. For instance, the UE 120 may obtain the burst parameters from an application client 1712 as depicted in FIG. 17C. At 1904, the UE 120 may transmit, to the RAN 150, bursts of files such as the traffic flow depicted in FIG. 15. The transmission of the traffic bursts may continue through the remainder of the operations 1900. At 1908, the RAN 150 may determine the burst parameters based on the parameters explicitly indicated at 1904 and/or implicitly from learning the structure of the traffic flow (e.g., burst start time, burst spread, burst end time, burst period).

At 1910, the RAN 150 may set sleep mode parameters for the UE 120 in accordance with the burst parameters and adjust the sleep mode parameters if the burst start times and/or burst spreads vary across bursts. At 1912, the RAN 150 may signal an indication of the sleep mode parameters (e.g., a configuration of sleep mode cycles and/or a command to enter a sleep or low power mode) to the UE 120. At 1914, the UE 120 may switch to a sleep mode between bursts in accordance with the sleep mode parameters.

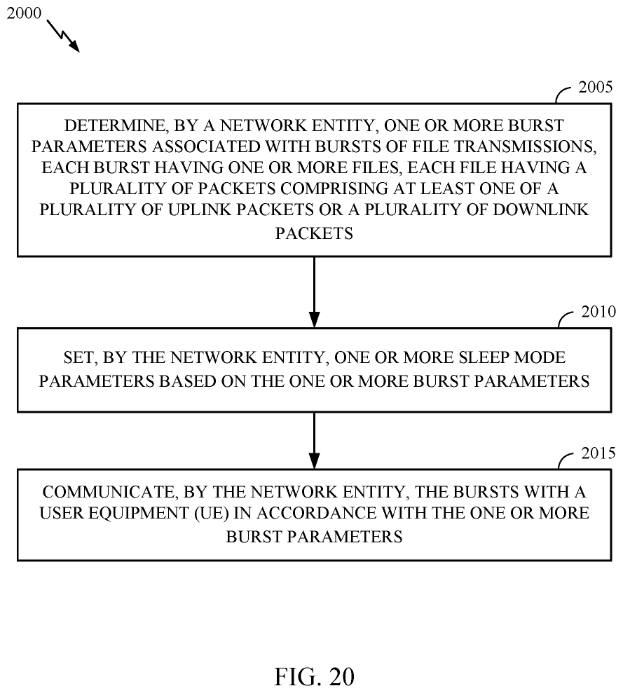

FIG. 20 is a flow diagram illustrating example operations 2000 for wireless communication by a network entity, in accordance with certain aspects of the present disclosure. The operations 2000 may be performed, for example, by a network entity (e.g., RAN 150 or BS 110). The operations 2000 may be implemented as software components that are executed and run on one or more processors (e.g., controller/processor 340 of FIG. 3). Further, the transmission and reception of signals by the network entity in operations 2000 may be enabled, for example, by one or more antennas (e.g., antennas 334 of FIG. 3). In certain aspects, the transmission and/or reception of signals by the network entity may be implemented via a bus interface of one or more processors (e.g., controller/processor 340) obtaining and/or outputting signals.

The operations 2000 may begin, at 2005, where the network entity determines one or more burst parameters associated with bursts of file transmissions. Each burst has one or more files and each file has a plurality of packets includes a plurality of uplink packets and/or a plurality of downlink packets. At 2010, the network entity may set one or more sleep mode parameters assigned to a UE (e.g., UE 120) based on the one or more burst parameters. At 2015, the network entity may communicate the bursts with the UE in accordance with the one or more burst parameters.

In certain aspects, the burst traffic may be downlink burst traffic, for example, as depicted in FIG. 18. The network entity may generate the files, and communicating with the UE at 2015 may include the network entity transmitting the bursts of file transmissions to the UE. In other aspects, the burst traffic may be uplink burst traffic, for example, as depicted in FIG. 19. Communicating with the UE at 1106 may include receiving the bursts from the UE.

The one or more burst parameters may include at least one of a burst start time (e.g., burst start time 1620), a burst end time (e.g., burst end time 1624), a burst spread (e.g., burst spread 1622), or a burst period (e.g., burst period 1626).

In aspects, the network entity may monitor the flow of burst traffic received or transmitted to the UE and determine the burst parameters based on the monitored traffic flow. For example, the network entity at 2005 may determine the one or more burst parameters by at least in part determining, if the bursts are periodic, a burst start time based on a periodicity of the bursts, determining a burst spread based on the burst spread being constant across the bursts, and determining a burst end time based on the burst start time and the burst spread.

In certain aspects, the network entity may learn some burst parameters from the traffic flow of bursts and receive other burst parameters explicitly from the server entity. For example, the network entity may receive, from an application function of the server entity (e.g., the edge cloud server 1430), an explicit indication of a constant burst spread (e.g., as depicted in FIG. 17A), and the network entity may determine, if the bursts are periodic, a burst start time based on a periodicity of the bursts and a burst end time based on the burst start time and the burst spread. In other words, where the burst spread is constant, the network entity may receive an explicit indication of the one or more burst parameters (e.g., a constant burst spread) from the server entity.

In aspects, the network entity may receive the burst parameters explicitly from the application function of the server entity, for example, as depicted in FIG. 17A. For example, the network entity may receive, from the application function, an indication of a burst start time relative to a reference clock (e.g., a shared clock) and a constant burst spread. The network entity may determine, if the bursts are periodic, the burst end time based on the burst start time and the burst spread.

In certain aspects, the network entity may receive the burst parameters explicitly from the data network (e.g., XR edge DN 1422) of a server entity, for example, as depicted in FIG. 17B. As an example, if the burst spread varies from burst to burst (i.e., the burst parameters include a varying burst spread), the network entity may receive, from the data network of a server entity via a user plane function of a core network, an explicit indication of the one or more burst parameters including a burst start time and a burst end time. The network entity may then determine a burst spread based on the burst start time and the burst end time.

In certain aspects, the network entity may receive the burst parameters explicitly from the UE (e.g., UE 120), for example, as depicted in FIG. 17C. As an example, the network entity may receive, from the UE, an indication of a burst start time and a burst spread, if the burst spread is constant. In other cases, the network entity may learn the burst start time from the uplink traffic flow and receive the burst spread explicitly from the UE.

In certain aspects, the sleep mode parameters may be any suitable parameter that enables the UE to conserve power consumption while communicating the bursts with the network entity. For example, the one or more sleep mode parameters may include at least one of a sleep duration associated with DRX cycles or a duration to monitor or refrain from monitoring downlink control signaling such as control signaling transmitted on the PDCCH. At 2010, setting the sleep mode parameters may include the network entity signaling an indication of the one or more sleep mode parameters to the UE. The network entity may signal the indication of the sleep mode parameters as a command to enter a lower power mode (e.g., a sleep mode) via at least one of a medium access control (MAC) control element, downlink control information (DCI), or radio resource control (RRC) element.

In certain aspects, the network entity may set the sleep mode parameters so that the UE enters sleep mode between bursts of traffic (e.g., between bursts 702 and 704). The sleep mode parameters may indicate to the UE to remain in sleep mode for the entire duration or a portion of the duration between the bursts of traffic. In aspects, the network entity may assume a burst start time is periodic and a burst spread is constant for each of the bursts and set the sleep mode parameters accordingly. In other aspects, the network entity may identify that the burst spread varies for each of the bursts and set the sleep mode parameters to accommodate the fluctuating bursts.

In cases where the network entity receives an indication of the one or more burst parameters, the indication of the one or more burst parameters may be received from an application function (e.g., XR edge AF 1424) of a server entity, for example, as depicted in FIG. 17A. The indication of the one or more burst parameters may be received from the application function via a PCF (e.g., PCF 1704) of the core network, a SMF (e.g., SMF 1706) of the core network, and an AMF (e.g., AMF 1708) of the core network. In other aspects, the indication of the one or more burst parameters may be received from the data network of a server entity via a UPF (e.g., UPF 1710) of a core network, for example, as depicted in FIG. 17B. At least one of the plurality of packets in one of the bursts may include a header indicating the one or more burst parameters.

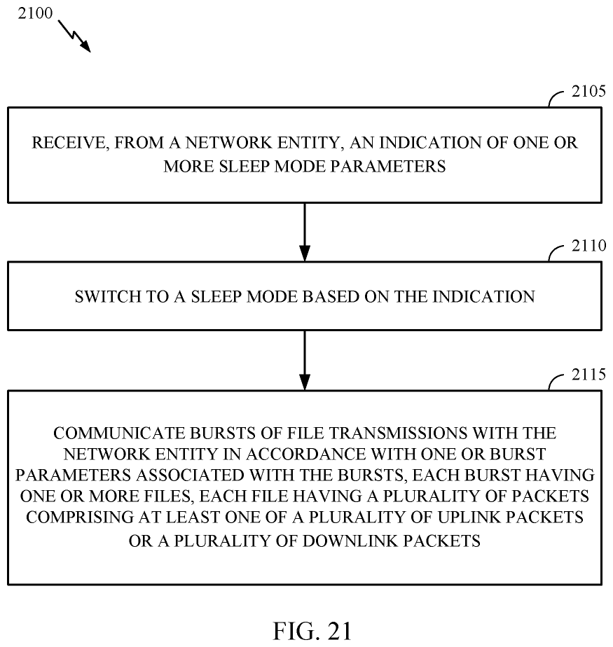

FIG. 21 is a flow diagram illustrating example operations 2100 for wireless communication E, in accordance with certain aspects of the present disclosure. The operations 2100 may be performed, for example, by a UE (e.g., UE 120). The operations 2100 may be complimentary to the operations 2000 performed by the network entity. The operations 2100 may be implemented as software components that are executed and run on one or more processors (e.g., controller/processor 380 of FIG. 3). Further, the transmission and reception of signals by the UE in operations 2100 may be enabled, for example, by one or more antennas (e.g., antennas 352 of FIG. 3). In certain aspects, the transmission and/or reception of signals by the UE may be implemented via a bus interface of one or more processors (e.g., controller/processor 380) obtaining and/or outputting signals.

The operations 2100 may begin, at 2105, where the UE may receive, from a network entity (e.g., RAN 150 or BS 110), an indication of one or more sleep mode parameters. At 2110, the UE may switch to a sleep mode based on the indication. At 2115, the UE may communicate bursts of file transmissions with the network entity in accordance with one or burst parameters associated with the bursts, each burst having one or more files, each file having a plurality of packets comprising at least one of a plurality of uplink packets or a plurality of downlink packets.

In certain aspects, the burst traffic may be downlink burst traffic, for example, as depicted in FIG. 18. Communicating with the network entity at 2115 may include the UE receiving the bursts from the network entity. In other aspects, the burst traffic may be uplink burst traffic, for example, as depicted in FIG. 19. The UE may generate the files (e.g., XR application files), and communicating with the network entity at 2115 may include transmitting the bursts of file transmission to the network entity.

In aspects, the UE may transmit the burst parameters to the network entity, for example, as depicted in FIG. 17C. For instance, the UE may determine the one or more burst parameters and transmit the one or more burst parameters to the network entity. In aspects, the UE may obtain an indication of the one or more burst parameters from an application client, for example, in a packet header.

The UE may receive, from the network entity, an indication of the one or more sleep mode parameters via at least one of a MAC control element, DCI, or RRC element. In aspects, the UE may receive a command to enter a lower power mode (e.g., a sleep mode) via at least one of the MAC control element, DCI, or RRC element. At 2110, switching to a sleep mode based on the indication may include the UE determining a sleep mode duration based on the indication and entering the sleep mode at the time(s) set in the indication. For example, the UE may be set to switch to a sleep mode between bursts of file traffic (e.g., between the entire duration or a portion of the duration between the bursts). The UE may continue to switch to a sleep mode between bursts while communicating the bursts of file transmissions with the network entity. That is, the UE may wake-up to communicate the bursts and switch to the sleep mode between bursts throughout the traffic flow. In aspects, the UE may be in a sleep mode while in a connected state (e.g., RRC connected mode) with the RAN. The sleep mode may be a duration for the UE to refrain from monitoring pages and/or control signaling, which may enable the UE to reduce its power consumption.

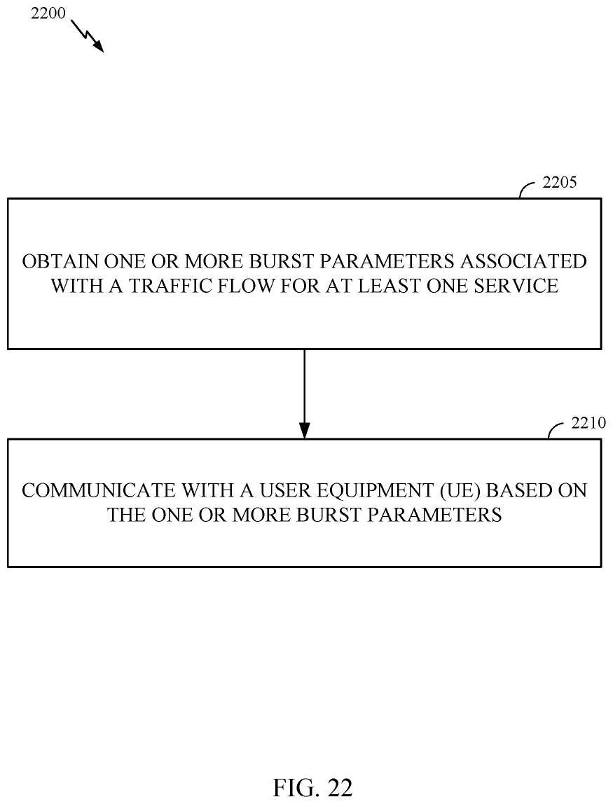

FIG. 22 is a flow diagram illustrating example operations 2200 that may be performed for communications. The operations 2200 may be performed by a network entity (e.g., as BS). The operations 2200 may begin, at 2205, by obtaining one or more burst parameters associated with a traffic flow for at least one service. At 2210, the operations 2200 may include communicating with a UE based on the one or more burst parameters.

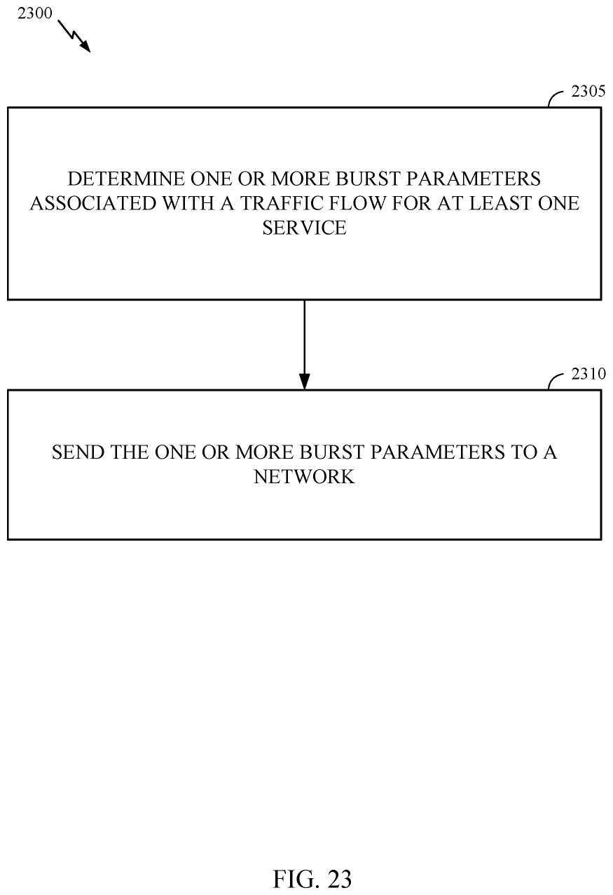

FIG. 23 is a flow diagram illustrating example operations 2300 that may be performed for communications. The operations 2300 may be performed by a network entity (e.g., an AF). The operations 2300 may begin, at 2305, by determining one or more burst parameters associated with a traffic flow for at least one service. At 2310, the operations 2300 may include sending the one or more burst parameters to a network.

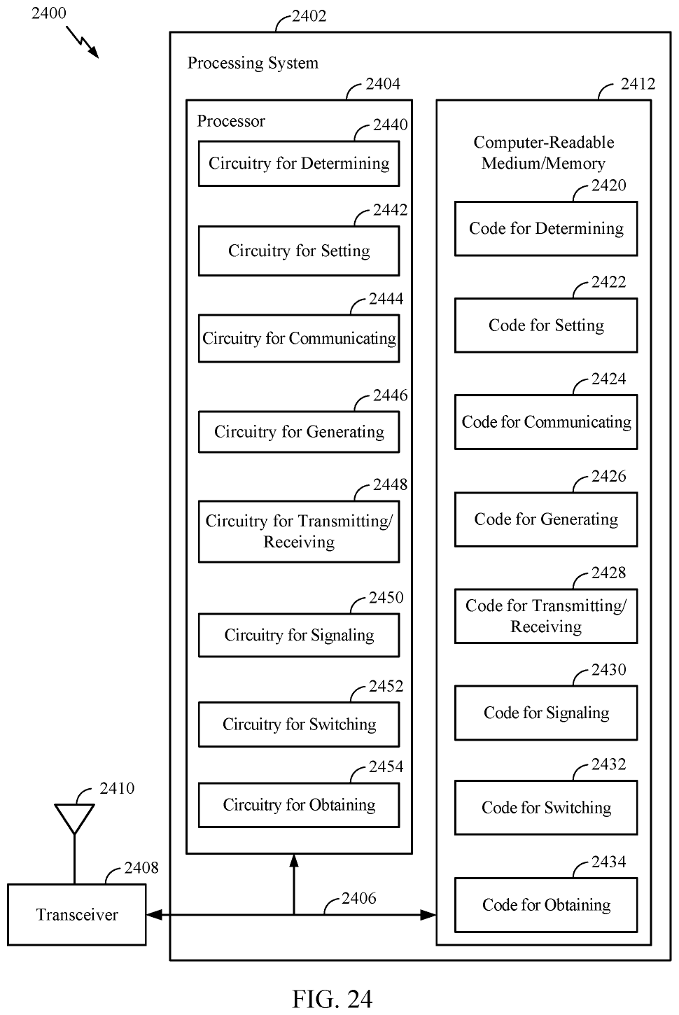

FIG. 24 illustrates a communications device 2400 (e.g., RAN 150, BS 110, AF, or UE 120) that may include various components (e.g., corresponding to means-plus-function components) configured to perform operations for the techniques disclosed herein, such as the operations illustrated in FIGS. 14-23. The communications device 2400 includes a processing system 2402 coupled to a transceiver 2408. The transceiver 2408 is configured to transmit and receive signals for the communications device 2400 via an antenna 2410, such as the various signals as described herein. The processing system 2402 may be configured to perform processing functions for the communications device 2400, including processing signals received and/or to be transmitted by the communications device 2400.

The processing system 2402 includes a processor 2404 coupled to a computer-readable medium/memory 2412 via a bus 2406. In certain aspects, the computer-readable medium/memory 2412 is configured to store instructions (e.g., computer-executable code) that when executed by the processor 2404, cause the processor 2404 to perform the operations illustrated in FIG. 14-23, or other operations for performing the various techniques discussed herein. In certain aspects, computer-readable medium/memory 2412 stores code for determining 2420, code for setting 2422, code for communicating 2424, code for generating 2426, code for transmitting (sending)/receiving 1248, code for signaling 2430, code for switching 2432, and/or code for obtaining 2434. In certain aspects, the processor 2404 has circuitry configured to implement the code stored in the computer-readable medium/memory 2412. The processor 2404 includes circuitry for determining 2440, circuitry for setting 2442, circuitry for communicating 2444, circuitry for generating 2446, circuitry for transmitting/receiving 2448, circuitry for signaling 2450, circuitry for switching 2452, and/or circuitry for obtaining 2454.

### Example Aspects

In a first aspect, a method for communications includes obtaining a burst factor associated with a minimum link rate and a latency at which coverage is provided for a traffic flow for at least one service; and utilizing the burst factor for admission control, resource allocation, or both.

In a second aspect, in combination with the first aspect, the at least one service includes augmented reality (AR), virtual reality (VR), cloud gaming, or a combination thereof.

In a third aspect, in combination with the one or more of the first and second aspects, the burst factor is a quality of service (QoS) parameter associated with a traffic burst of the traffic flow for the at least one service.

In a fourth aspect, in combination with one or more of the first through third aspects, the burst factor is associated with a size of one or more traffic bursts for the traffic flow, an arrival pattern of the one or more traffic bursts for the traffic flow, or a combination thereof.

In a fifth aspect, in combination with one or more of the first through fourth aspects, a burst throughput of the traffic flow for at least one service is greater than a guaranteed bit rate (GBR).

In a sixth aspect, in combination with one or more of the first through fifth aspects, the coverage is provided when a number of packets lost or delayed by more than a packet delay budget (PDB) is less than a packet error rate (PER).

In a seventh aspect, in combination with one or more of the first through sixth aspects, a throughput of the traffic flow for at least one service is greater than 32.76 Mbps.

In an eighth aspect, in combination with one or more of the first through seventh aspects, obtaining the burst factor includes determining the burst factor.

In a ninth aspect, in combination with one or more of the first through eighth aspects, the method includes receiving, at a base station (BS) in a network, information from a network entity in the network, wherein the BS determines the burst factor based on the information.

In a tenth aspect, in combination with one or more of the first through ninth aspects, the method includes receiving, at a network entity in a network, information from an application server, wherein the network entity determines the burst factor based on the information.

In an eleventh aspect, in combination with one or more of the first through tenth aspects, determining the burst factor includes simulating or monitoring a traffic flow on a communication link of constant link rate; and determining a minimum constant link rate at which one or more quality-of-service (QoS) parameters are met for the traffic flow.

In a twelfth aspect, in combination with one or more of the first through eleventh aspects, determining the burst factor includes monitoring burst-rates over a plurality of durations; excluding one or more of the monitored burst-rates based on a packet error rate (PER); and calculating the burst factor based on a multiplication factor at which a highest remaining burst-rate exceeds an average bit-rate of the traffic flow.

In a thirteenth aspect, in combination with one or more of the first through twelfth aspects, the plurality of durations includes packet delay budgets (PDBs).

In a fourteenth aspect, in combination with one or more of the first through thirteenth aspects, obtaining the burst factor includes receiving signaling indicating the burst factor.

In a fifteenth aspect, in combination with one or more of the first through fourteenth aspects, the signaling indicating the burst factor is received at a network entity from an application server, an application function (AF), or another network entity.

In a sixteenth aspect, in combination with one or more of the first through fifteenth aspects, the signaling indicating the burst factor is received at a base station (BS) from a network entity or another BS.

In a seventeenth aspect, in combination with one or more of the first through sixteenth aspects, the network entity comprises an AMF (access and mobility management function) or policy and charging control (PCC).

In an eighteenth aspect, in combination with one or more of the first through seventeenth aspects, the burst factor is signaled via a new message, a new field in an existing message, an interpretation of an existing field, or a combination thereof.

In a nineteenth aspect, in combination with one or more of the first through eighteenth aspects, the burst factor is signaled via one or more bits of a maximum data bits volume (MDBV) field.

In a twentieth aspect, in combination with one or more of the first through nineteenth aspects, the MDBV is a product of the burst factor, a guaranteed bit rate (GBR), and a packet delay budget (PDB).

In a twenty-first aspect, in combination with one or more of the first through twentieth aspects, utilizing the burst factor for admission control includes performing admission control using the burst factor, providing the burst factor to an admission control device, or a combination thereof.

In a twenty-second aspect, in combination with one or more of the first through twenty-second aspects, utilizing the burst factor for admission control includes receiving a request for the at least one service for a user equipment (UE); determining whether a quality-of-service (QoS) for the at least one service can be met based on the burst factor; and determining whether to admit the at least one service for the UE based on the determination.

In a twenty-third aspect, in combination with one or more of the first through twenty-second aspects, determining whether the QoS for the at least one service can be met based on the burst factor includes determining an expected rate of a link with the UE; and determining whether the expected rate of the link with the UE is higher than a product of the burst factor, a guaranteed bit rate (GBR), and a packet delay budget (PDB).

In a twenty-fourth aspect, in combination with one or more of the first through twenty-third aspects, utilizing the burst factor for resource allocation includes performing scheduling resources based on the burst factor, providing the burst factor to a scheduling device, or a combination thereof.

In a twenty-fifth aspect, in combination with one or more of the first through twenty-fourth aspects, utilizing the burst factor for resource allocation includes determining a traffic pattern of one or more traffic bursts scheduled or to be scheduled; and allocating one or more resources based on the burst factor.

In a twenty-sixth aspect, in combination with one or more of the first through twenty-fifth aspects, determining the traffic pattern of the one or more traffic bursts scheduled or to be scheduled includes receiving an indication of the traffic pattern from an application server, wherein the traffic pattern indicates the one or more traffic bursts for a plurality of user equipments (UEs); determining one or more overlapping traffic bursts for at least two of the plurality of UEs; and allocating one or more resources based on the overlap.

In a twenty-seventh aspect, in combination with one or more of the first through twenty-sixth aspects, the method includes sending an indication to an admission control device indicating whether a resource allocation can avoid the overlap.

In a twenty-eighth aspect, a method for communications includes determining a burst factor associated with a minimum link rate and a latency at which coverage is provided for a traffic flow for at least one service, information associated with the burst factor, or both; and sending the burst factor, the information associated with the burst factor, or both to a network.

In a twenty-ninth aspect, in combination with the twenty-eighth aspect, the at least one service comprises augmented reality (AR), virtual reality (VR), cloud gaming, or a combination thereof.

In a thirtieth aspect, in combination with one or more of the twenty-eighth and twenty-ninth aspects, the burst factor comprises a quality of service (QoS) parameter associated with a traffic burst of the traffic flow for the at least one service.

In a thirty-first aspect, in combination with one or more of the twenty-eighth through thirtieth aspects, the burst factor is associated with a size of one or more traffic bursts for the traffic flow, an arrival pattern of the one or more traffic bursts for the traffic flow, or a combination thereof.

In a thirty-second aspect, in combination with one or more of the twenty-eighth through thirty-first aspects, a burst throughput of the traffic flow for at least one service is greater than a guaranteed bit rate (GBR).

In a thirty-third aspect, in combination with one or more of the twenty-eighth through thirty-second aspects, the coverage is provided when a number of packets lost or delayed by more than a packet delay budget (PDB) is less than a packet error rate (PER).

In a thirty-fourth aspect, in combination with one or more of the twenty-eighth through thirty-third aspects, a throughput of the traffic flow for at least one service is greater than 32.76 Mbps.

In a thirty-fifth aspect, in combination with one or more of the twenty-eighth through thirty-fourth aspects, the burst factor, information associated with the burst factor, or both is sent from an application server to an application function (AF) in the network, an AMF (access and mobility management function) in the network, a policy and charging control (PCC) in the network, another network entity in the network, or a combination thereof.

In a thirty-sixth aspect, in combination with one or more of the twenty-eighth through thirty-fifth aspects, determining the burst factor includes simulating or monitoring a traffic flow on a communication link of constant link rate; and determining a minimum constant link rate at which one or more quality-of-service (QoS) parameters are met for the traffic flow.

In a thirty-seventh aspect, in combination with one or more of the twenty-eighth through thirty-sixth aspects, determining the burst factor includes monitoring burst-rates over a plurality of durations; excluding one or more of the monitored burst-rates based on a packet error rate (PER); and calculating the burst factor based on a multiplication factor at which a highest remaining burst-rate exceeds an average bit-rate of the traffic flow.

In a thirty-eighth aspect, in combination with one or more of the twenty-eighth through thirty-seventh aspects, the plurality of durations include packet delay budgets (PDBs).

In a thirty-ninth aspect, in combination with one or more of the twenty-eighth through thirty-eighth aspects, the burst factor is signaled via a new message, a new field in an existing message, an interpretation of an existing field, or a combination thereof.

In a fortieth aspect, in combination with one or more of the twenty-eighth through thirty-ninth aspects, the burst factor is signaled via one or more bits of a maximum data bits volume (MDBV) field.

In a forty-first aspect, in combination with one or more of the twenty-eighth through fortieth aspects, the MDBV is a product of the burst factor, a guaranteed bit rate (GBR), and a packet delay budget (PDB).

In a forty-second aspect, a method for communications includes determining one or more burst parameters associated with bursts of file transmissions, each burst having one or more files, each file having a plurality of packets comprising at least one of a plurality of uplink packets or a plurality of downlink packets; setting one or more sleep mode parameters based on the one or more burst parameters; and communicating the bursts with a user equipment (UE) in accordance with the one or more burst parameters.

In a forty-third aspect, in combination with the forty-second aspect, the method includes generating the files; and communicating the bursts includes transmitting the bursts to the UE.

In a forty-fourth aspect, in combination with one or more of the forty-second and forty-third aspects, communicating the bursts includes receiving the bursts from the UE.

In a forty-fifth aspect, in combination with one or more of the forty-second through forty-fourth aspects, determining the one or more burst parameters includes, if the bursts are periodic, determining a burst start time based on a periodicity of the bursts, determining a burst spread based on the burst spread being constant across the bursts, and determining a burst end time based on the burst start time and the burst spread.

In a forty-sixth aspect, in combination with one or more of the forty-second through forty-fifth aspects, the method includes receiving an explicit indication of a constant burst spread from a an application function of a server entity, and wherein determining the one or more burst parameters comprises, if the bursts are periodic, determining a burst start time based on a periodicity of the bursts and determining a burst end time based on the burst start time and the burst spread.

In a forty-seventh aspect, in combination with one or more of the forty-second through forty-sixth aspects, the method includes receiving, from an application function of a server entity, an indication of a burst start time relative to a reference clock and a constant burst spread, and wherein determining the one or more burst parameters comprises, if the bursts are periodic, determining a burst end time based on the burst start time and the burst spread.

In a forty-eighth aspect, in combination with one or more of the forty-second through forty-seventh aspects, the method includes receiving, from a data network of a server entity via a user plane function of a core network, an explicit indication of a burst start time and a burst end time, and wherein determining the one or more burst parameters comprises determining a burst spread based on the burst start time and the burst end time.

In a forty-ninth aspect, in combination with one or more of the forty-second through forty-eighth aspects, the one or more burst parameters comprise at least one of a burst start time, a burst end time, a burst spread, or a burst period.

In a fiftieth aspect, in combination with one or more of the forty-second through forty-ninth aspects, the burst spread is a duration of a burst from the burst start time to the burst end time.

In a fifty-first aspect, in combination with one or more of the forty-second through fiftieth aspects, the burst period is a duration between burst start times of consecutive bursts.

In a fifty-second aspect, in combination with one or more of the forty-second through fifty-first aspects, the one or more sleep mode parameters comprise at least one of a sleep duration associated with discontinuous reception (DRX) cycles or a duration to monitor downlink control signaling.

In a fifty-third aspect, in combination with one or more of the forty-second through fifty-second aspects, setting the sleep mode parameters includes signaling an indication of the one or more sleep mode parameters to the UE.

In a fifty-fourth aspect, in combination with one or more of the forty-second through fifty-third aspects, signaling the indication of the one or more sleep mode parameters comprises signaling a command to enter a low power mode via at least one of a medium access control (MAC) control element or downlink control information (DCI).

In a fifty-fifth aspect, in combination with one or more of the forty-second through fifty-fourth aspects, setting the one or more sleep mode parameters includes assuming a burst start time is periodic and a burst spread is constant for each of the bursts.

In a fifty-sixth aspect, in combination with one or more of the forty-second through fifty-fifth aspects, setting the one or more sleep mode parameters comprises identifying that a burst spread varies for each of the bursts.

In a fifty-seventh aspect, in combination with one or more of the forty-second through fifty-sixth aspects, the method includes receiving an indication of the one or more burst parameters from an application function of a server entity, wherein the one or more burst parameters comprise a constant burst spread.

In a fifty-eighth aspect, in combination with one or more of the forty-second through fifty-seventh aspects, the indication of the one or more burst parameters is received from the application function via a policy control function (PCF) of a core network, a session management function (SMF) of the core network, and an access and mobility management function (AMF) of the core network.

In a fifty-ninth aspect, in combination with one or more of the forty-second through fifty-eighth aspects, the method includes receiving an indication of the one or more burst parameters from a data network of a server entity, wherein the one or more burst parameters comprise a varying burst spread.

In a sixtieth aspect, in combination with one or more of the forty-second through fifty-ninth aspects, the indication of the one or more burst parameters is received from the data network via a user plane function of a core network.

In a sixty-first aspect, in combination with one or more of the forty-second through sixtieth aspects, at least one of the plurality of packets includes a header indicating the one or more burst parameters.

In a sixty-second aspect, in combination with one or more of the forty-second through sixty-first aspects, the method includes receiving, from a network entity, an indication of the one or more burst parameters from the UE.

In a sixty-third aspect, a method for communications includes receiving, from a network entity, an indication of one or more sleep mode parameters; switching to a sleep mode based on the indication; and communicating bursts of file transmissions with the network entity in accordance with one or burst parameters associated with the bursts, each burst having one or more files, each file having a plurality of packets comprising at least one of a plurality of uplink packets or a plurality of downlink packets.

In a sixty-fourth aspect, in combination with the sixty-third aspect, the method includes generating the files; and communicating the bursts includes transmitting the bursts to the network entity.

In a sixty-fifth aspect, in combination with one or more the sixty-third and sixty-fourth aspects, communicating the bursts includes receiving the bursts from the network entity.

In a sixty-sixth aspect, in combination with one or more the sixty-third through sixty-fifth aspects, the one or more burst parameters comprise at least one of a burst start time, a burst end time, a burst spread, or a burst period.

In a sixty-seventh aspect, in combination with one or more the sixty-third through sixty-sixth aspects, the burst spread is a duration of a burst from the burst start time to the burst end time.

In a sixty-eighth aspect, in combination with one or more the sixty-third through sixty-seventh aspects, the burst period is a duration between burst start times of consecutive bursts.

In a sixty-ninth aspect, in combination with one or more the sixty-third through sixty-eighth aspects, the one or more sleep mode parameters comprise at least one of a sleep duration associated with discontinuous reception (DRX) cycles or a duration to monitor downlink control signaling.

In a seventieth aspect, in combination with one or more the sixty-third through sixty-ninth aspects, receiving the indication of the one or more sleep mode parameters includes receiving a command to enter a low power mode via at least one of a medium access control (MAC) control element or downlink control information (DCI).

In a seventy-first aspect, in combination with one or more the sixty-third through seventieth aspects, the method includes determining the one or more burst parameters associated with the bursts; and transmitting the one or more burst parameters to the network entity.

In a seventy-second aspect, in combination with one or more the sixty-third through seventy-first aspects, the method includes obtaining an indication of the one or more burst parameters from an application client.

In a seventy-third aspect, a method for communications includes obtaining one or more burst parameters associated with a traffic flow for at least one service and communicating with a user equipment (UE) based on the one or more burst parameters.

In a seventy-fourth aspect, in combination with the seventy-third aspect, obtaining the one or more burst parameters includes receiving signaling indicating the one or more burst parameters.

In a seventy-fifth aspect, in combination with the seventy-fourth aspect, the signaling indicating the one or more burst parameters is received at a network entity from an application function (AF).

In a seventy-sixth aspect, in combination with one or more of the seventy-fourth and seventy-fifth aspects, the one or more burst parameters are signaled via a new message, a new field in an existing message, an interpretation of an existing field, or a combination thereof.

In a seventy-seventh aspect, in combination with the seventy-sixth aspect, the one or more burst parameters are signaled via one or more bits of a maximum data bits volume (MDBV) field.

In a seventy-eighth aspect, in combination with one or more of the seventy-third through seventy-ninth aspects, the one more burst parameters includes a burst factor that is a multiplicative factor for a guaranteed bit rate (GBR) and defines a minimum bit rate for providing coverage for the traffic flow for the at least one service.

In a seventy-ninth aspect, in combination with the seventy-eighth aspect, the burst factor is associated with a size of one or more traffic bursts for the traffic flow, an arrival pattern of the one or more traffic bursts for the traffic flow, or a combination thereof.

In an eightieth aspect, in combination with the one or more of the seventy-eighth and seventy-ninth aspects, the throughput of the traffic flow for at least one service is greater than 32.76 Mbps.

In an eighty-first aspect, in combination with one or more of the seventy-eighth through eightieth aspects, communicating with the UE based on the one or more burst parameters includes utilizing the burst factor for admission control, resource allocation, or both.

In an eighty-second aspect, in combination with the eighty-first aspect, utilizing the burst factor for admission control includes receiving a request for the at least one service for the UE; determining whether a quality-of-service (QoS) for the at least one service can be met based on the burst factor; and determining whether to admit the at least one service for the UE based on the determination.

In an eighty-third aspect, in combination with the eighty-second aspect, determining whether the QoS for the at least one service can be met based on the burst factor includes determining an expected rate of a link with the UE; and determining whether the expected rate of the link with the UE is higher than a product of the burst factor, the GBR, and a packet delay budget (PDB).

In an eighty-fourth aspect, in combination with the eighty-third aspect, utilizing the burst factor for resource allocation includes determining a traffic pattern of one or more traffic bursts scheduled or to be scheduled; and allocating one or more resources based on the burst factor associated with the traffic pattern.

In an eighty-fifth aspect, in combination with the eighty-fourth aspect, determining the traffic pattern of the one or more traffic bursts scheduled or to be scheduled includes receiving an indication of the traffic pattern from an application server, wherein the traffic pattern indicates the one or more traffic bursts for a plurality of UEs; determining one or more overlapping traffic bursts for at least two of the plurality of UEs; and allocating one or more resources based on the overlap.

In an eighty-sixth aspect, in combination with the one or of the seventy-third through eighty-fifth aspects, the one or more burst parameters comprises a burst start time, a burst spread, a burst end time, a burst period, or a combination thereof.

In an eighty-seventh aspect, in combination with the eighty-sixth aspect, communicating with the UE based on the one or more burst parameters includes setting one or more sleep mode parameters based on the one or more burst parameters.

In an eighty-eighth aspect, in combination with the eighty-seventh aspect, the one or more sleep mode parameters include at least one of a sleep duration associated with discontinuous reception (DRX) cycles or a duration to monitor downlink control signaling.

In an eighty-ninth aspect, in combination with one or more of the eighty-seventh and eighty-eighth aspects, setting the sleep mode parameters includes signaling an indication of the one or more sleep mode parameters to the UE.

In a ninetieth aspect, a method for communications includes determining one or more burst parameters associated with a traffic flow for at least one service; and sending the one or more burst parameters to a network.

In a ninety-first aspect, in combination with the ninetieth aspect, sending the one or more burst parameters includes sending the one or more burst parameters to a network entity from an application function (AF).

In a ninety-second aspect, in combination with one or more of the ninetieth and ninety-first aspects, the one or more burst parameters are signaled via a new message, a new field in an existing message, an interpretation of an existing field, or a combination thereof.

In a ninety-third aspect, in combination with the ninety-second aspect, the one or more burst parameters are signaled via one or more bits of a maximum data bits volume (MDBV) field.

In a ninety-fourth aspect, in combination with one or more of the ninetieth through ninety-third aspects, the one more burst parameters comprises a burst factor that is a multiplicative factor for a guaranteed bit rate (GBR) and defines a minimum bit rate for providing coverage for the traffic flow for the at least one service.

In a ninety-fifth aspect, in combination with the ninety-fourth aspect, the burst factor is associated with a size of one or more traffic bursts for the traffic flow, an arrival pattern of the one or more traffic bursts for the traffic flow, or a combination thereof.

In a ninety-sixth aspect, in combination with one or more of the ninety-fourth and ninety-fifth aspects, a throughput of the traffic flow for at least one service is greater than 32.76 Mbps.

In a ninety-seventh aspect, in combination with one or more of the ninety-fourth through ninety-sixth aspects, determining the burst factor includes simulating or monitoring a traffic flow on a communication link of constant link rate; and determining a minimum constant link rate at which one or more quality-of-service (QoS) parameters are met for the traffic flow.

In a ninety-eighth aspect, in combination with one or more of the ninety-fourth through ninety-seventh aspects, the determining the burst factor includes monitoring burst-rates over a plurality of durations; excluding one or more of the monitored burst-rates based on a packet error rate (PER); and calculating the burst factor based on a multiplication factor at which a highest remaining burst-rate exceeds an average bit-rate of the traffic flow.

In a ninety-ninth aspect, in combination with the ninety-eighth aspect, the plurality of durations includes packet delay budgets (PDBs).

In a hundredth aspect, in combination with one or more of the ninetieth through ninety-ninth aspects, the one or more burst parameters includes a burst start time, a burst spread, a burst end time, a burst period, or a combination thereof.

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. ABS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communications device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIGS. 8-11 and/or FIGS. 18-22.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method for communications, comprising:
obtaining one or more burst parameters associated with a traffic flow for at least one service; and
communicating with a user equipment (UE) based on the one or more burst parameters.

2. The method of claim 1, wherein obtaining the one or more burst parameters comprises receiving signaling indicating the one or more burst parameters.

3. The method of claim 2, wherein the signaling indicating the one or more burst parameters is received at a network entity from an application function (AF).

4. The method of claim 2, wherein the one or more burst parameters are signaled via a new message, a new field in an existing message, an interpretation of an existing field, or a combination thereof.

5. The method of claim 4, wherein the one or more burst parameters are signaled via one or more bits of a maximum data bits volume (MDBV) field.

6. The method of claim 1, wherein the one more burst parameters comprises a burst factor that is a multiplicative factor for a guaranteed bit rate (GBR) and defines a minimum bit rate for providing coverage for the traffic flow for the at least one service.

7. The method of claim 6, wherein the burst factor is associated with a size of one or more traffic bursts for the traffic flow, an arrival pattern of the one or more traffic bursts for the traffic flow, or a combination thereof.

8. The method of claim 6, wherein a throughput of the traffic flow for at least one service is greater than 32.76 Mbps.

9. The method of claim 6, wherein communicating with the UE based on the one or more burst parameters comprises utilizing the burst factor for admission control, resource allocation, or both.

10. The method of claim 9, wherein utilizing the burst factor for admission control comprises:
receiving a request for the at least one service for the UE;
determining whether a quality-of-service (QoS) for the at least one service can be met based on the burst factor; and
determining whether to admit the at least one service for the UE based on the determination.

11. The method of claim 10, wherein determining whether the QoS for the at least one service can be met based on the burst factor comprises:
determining an expected rate of a link with the UE; and
determining whether the expected rate of the link with the UE is higher than a product of the burst factor, the GBR, and a packet delay budget (PDB).

12. The method of claim 11, wherein utilizing the burst factor for resource allocation comprises:
determining a traffic pattern of one or more traffic bursts scheduled or to be scheduled; and
allocating one or more resources based on the burst factor associated with the traffic pattern.

13. The method of claim 12, wherein:
determining the traffic pattern of the one or more traffic bursts scheduled or to be scheduled comprises:
receiving an indication of the traffic pattern from an application server, wherein the traffic pattern indicates the one or more traffic bursts for a plurality of UEs;
determining one or more overlapping traffic bursts for at least two of the plurality of UEs; and
allocating one or more resources based on the overlap.

14. The method of claim 1, wherein the one or more burst parameters comprises a burst start time, a burst spread, a burst end time, a burst period, or a combination thereof.

15. The method of claim 14, wherein communicating with the UE based on the one or more burst parameters comprises setting one or more sleep mode parameters based on the one or more burst parameters.

16. The method of claim 15, wherein the one or more sleep mode parameters comprise at least one of a sleep duration associated with discontinuous reception (DRX) cycles or a duration to monitor downlink control signaling.

17. The method of claim 15, wherein setting the sleep mode parameters comprises signaling an indication of the one or more sleep mode parameters to the UE.

18. A method for communications, comprising:
determining one or more burst parameters associated with a traffic flow for at least one service; and
sending the one or more burst parameters to a network.

19. The method of claim 18, wherein the sending the one or more burst parameters comprises sending the one or more burst parameters to a network entity from an application function (AF).

20. The method of claim 18, wherein the one or more burst parameters are signaled via a new message, a new field in an existing message, an interpretation of an existing field, or a combination thereof.

21. The method of claim 20, wherein the one or more burst parameters are signaled via one or more bits of a maximum data bits volume (MDBV) field.

22. The method of claim 18, wherein the one more burst parameters comprises a burst factor that is a multiplicative factor for a guaranteed bit rate (GBR) and defines a minimum bit rate for providing coverage for the traffic flow for the at least one service.

23. The method of claim 22, wherein the burst factor is associated with a size of one or more traffic bursts for the traffic flow, an arrival pattern of the one or more traffic bursts for the traffic flow, or a combination thereof.

24. The method of claim 22, wherein a throughput of the traffic flow for at least one service is greater than 32.76 Mbps.

25. The method of claim 22, wherein determining the burst factor comprises:
simulating or monitoring a traffic flow on a communication link of constant link rate; and
determining a minimum constant link rate at which one or more quality-of-service (QoS) parameters are met for the traffic flow.

26. The method of claim 22, wherein the determining the burst factor comprises:
monitoring burst-rates over a plurality of durations;
excluding one or more of the monitored burst-rates based on a packet error rate (PER); and
calculating the burst factor based on a multiplication factor at which a highest remaining burst-rate exceeds an average bit-rate of the traffic flow.

27. The method of claim 26, wherein the plurality of durations comprises packet delay budgets (PDBs).

28. The method of claim 18, wherein the one or more burst parameters comprises a burst start time, a burst spread, a burst end time, a burst period, or a combination thereof.

29. An apparatus for communications, comprising:
at least one processor; and
a memory coupled to the at least one processor, the at least one processor and the memory configured to:
obtain one or more burst parameters associated with a traffic flow for at least one service; and
communicate with another apparatus based on the one or more burst parameters.

30. An apparatus for communications, comprising:
at least one processor; and
a memory coupled to the at least one processor, the at least one processor and the memory configured to:
determine one or more burst parameters associated with a traffic flow for at least one service; and
send the one or more burst parameters to a network.
